(19) United States
(12) Patent Application Publication
(10) Pub. No.: US 2026/0222866 A1
(43) Pub. Date: Jul. 30, 2026

(54) SYSTEMS AND METHODS FOR EXTENDING REFERENCE SIGNALS FOR MEASUREMENTS FOR UPLINK AND DOWNLINK TRANSMISSIONS

(71) Applicant: Telefonaktiebolaget LM Ericsson (PUBL), Stockholm (SE)

(72) Inventors: Mattias FRENNE, UPPSALA (SE); Qiang ZHANG, TÄBY (SE); Claes Tidestav, BÅLSTA (SE); Stefan PARKVALL, BROMMA (SE)

(21) Appl. No.: 19/144,608

(22) PCT Filed: Dec. 29, 2023
(86) PCT No.: PCT/IB2023/063388

§ 371 Date: Jun. 30, 2025

Related U.S. Application Data
(60) Provisional application No. 63/478,121, filed on Dec. 31, 2022.
(60) Provisional application No. 63/478,122, filed on Dec. 31, 2022.

(51) Int. Cl. H04W 24/10; H04L 5/00

(52) U.S. Cl. CPC H04W 24/10; H04L 5/0051

(57) ABSTRACT

A method (800) by a user equipment, UE (112, 200), is provided for extending Reference Signals, RS, for a downlink RS transmission and/or an uplink RS transmission. The method includes receiving (802), from a network node (110, 300), a scheduling assignment associated with the downlink RS transmission or the uplink RS transmission. The scheduling assignment includes an indication of a transmission rank associated with a first number of ports, R. The scheduling assignment also includes an indication to perform, for the downlink RS transmission, at least one measurement on a second number of ports, Q, or an indication to transmit the uplink RS transmission on a second number of ports, Q. The UE transmits (804), to the network node, a measurement report based on the second number of ports, Q or the uplink RS transmission on the second number of ports, Q. Data is mapped to the first number of ports, R.

### TECHNICAL FIELD

The present disclosure relates, in general, to wireless communications and, more particularly, systems and methods for extending reference signals for measurements for uplink and downlink transmissions.

### BACKGROUND

New Radio (NR) uses Cyclic Prefix Orthogonal Frequency Division Multiplexing (CP-OFDM) in both downlink (i.e., from a network node, gNodeB (gNB), or base station, to a user equipment (UE) and uplink (i.e., from UE to gNB or base station). Discrete Fourier Transform (DFT) spread OFDM is also supported in the uplink.

In the time domain, NR downlink (DL) and uplink (UL) are organized into equally-sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically on a slot basis. FIG. 1 illustrates an example NR time domain structure with a 14-symbol slot and 15 KHz subcarrier spacing. As illustrated, the first two symbols contain physical downlink control channel (PDCCH) and the rest contains physical shared data channel, which is either physical downlink shared channel (PDSCH) or physical uplink shared channel (PUSCH).

Different subcarrier spacing values are supported in NR. The supported subcarrier spacing values (also referred to as different numerologies) are given by Δf=(15×2^{μ}) kHz where μ∈0, 1, 2, 3, 4. Δf=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. FIG. 2 illustrates the basic NR physical time-frequency resource grid. Only one RB within a 14-symbol slot is shown. One OFDM subcarrier during one OFDM symbol interval forms one resource element (RE).

DL PDSCH transmissions can be either dynamically scheduled, i.e., in each slot the gNB transmits downlink control information (DCI) over PDCCH about which UE data is to be transmitted to and which RBs in the current DL slot the data is transmitted on, or semi-persistently scheduled (SPS) in which periodic PDSCH transmissions are activated or deactivated by a DCI. Different DCI formats are defined in NR for DL PDSCH scheduling including DCI format 1_0, DCI format 1_1, and DCI format 1_2.

Similarly, UL PUSCH transmission can also be scheduled either dynamically or semi-persistently with UL grants carried in PDCCH. NR supports two types of semi-persistent UL transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include DCI format 0_0, DCI format 0_1, and DCI format 0_2.

The new generation mobile wireless communication system (5G or NR), supports a diverse set of use cases and a diverse set of deployment scenarios. The later includes deployment at both low frequencies (100s of MHz), similar to Long Term Evolution (LTE) today, and very high frequencies (mm waves in the tens of GHz). At high frequencies, propagation characteristics make achieving good coverage challenging. One solution to the coverage issue is to employ high-gain beamforming, typically in an analog manner, in order to achieve satisfactory link budget.

NR uses OFDM in the DL and UL. FIG. 3 illustrates the basic LTE and NR DL physical resource as a time-frequency grid, where each resource element corresponds to one OFDM subcarrier during one OFDM symbol interval. Although a subcarrier spacing of Δf=15 kHz is shown in FIG. 3, different subcarrier spacing values are supported in NR, which uses OFDM in the DL and UL. The supported subcarrier spacing values (also reference to as different numerologies) in NR are given by Δf=(15×2^{α}) kHz where α is a non-negative integer.

FIG. 4 illustrates the NR time domain structure. Specifically, in the time domain, DL transmissions are organized into radio frames of 10 ms, each radio frame consisting of ten equally-sized subframes of length T_{subframe}=1 ms, as illustrated in FIG. 4. While a subframe is always 1 ms, in NR, a slot length for a (15×2^{α}) kHz subcarrier spacing is y ½_{α} ms.

As described above, resource allocation in is typically described in terms of RBs, where a RB corresponds to one slot (14 OFDM symbols) in the time domain and 12 contiguous subcarriers in the frequency domain. RBs are numbered in the frequency domain, starting with 0 from one end of the bandwidth part.

DL transmissions are dynamically scheduled, i.e., in each subframe the gNB transmits control information about to which terminals data is transmitted and upon which RBs the data is transmitted, in the current DL subframe. This control signaling is typically transmitted in the first 1, 2, 3 or 4 OFDM symbols in each slot in NR.

### Codebook-Based Precoding

Multi-antenna techniques can significantly increase the data rates and reliability of a wireless communication system. The performance is in particular improved if both the transmitter and the receiver are equipped with multiple antennas, which results in a multiple-input multiple-output (MIMO) communication channel. Such systems and/or related techniques are commonly referred to as MIMO.

A core component in NR is the support of MIMO antenna deployments and MIMO related techniques including beamforming at higher carrier frequencies. Currently, LTE and NR support an 8-layer spatial multiplexing mode to a single UE for up to 32 Tx antennas with channel dependent precoding. The spatial multiplexing mode is aimed for high data rates in favorable channel conditions. FIG. 5 illustrates a transmission structure of precoded spatial multiplexing mode in NR.

As seen, the information carrying symbol vector s is multiplied by an N_{T}×r precoder matrix W, which serves to distribute the transmit energy in a subspace of the N_{T} (corresponding to N_{T} antenna ports) dimensional vector space. The precoder matrix is typically selected from a codebook of possible precoder matrices, and typically indicated by means of a precoder matrix indicator (PMI), which specifies a unique precoder matrix in the codebook for a given number of symbol streams. The r symbols in s each correspond to a layer and r is referred to as the transmission rank. In this way, spatial multiplexing is achieved since multiple symbols can be transmitted simultaneously over the same time/frequency resource element (TFRE). The number of symbols r is typically adapted to suit the current channel properties.

NR uses OFDM in the DL and, thus, the received N_{R}×1 vector yₙ for a certain TFRE on subcarrier n (or alternatively data TFRE number n) is thus modeled by:

$${y}_{n} = {H}_{n} W {s}_{n} + {e}_{n}$$

where eₙ is a noise/interference vector obtained as realizations of a random process. The precoder, W, can be a wideband precoder, which is constant over frequency, or frequency selective.

The precoder matrix is often chosen to match the characteristics of the N_{R}×N_{T} MIMO channel matrix Hₙ, resulting in so-called channel dependent precoding. This is also commonly referred to as closed-loop precoding and essentially strives for focusing the transmit energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced.

The transmission rank and, thus, the number of spatially multiplexed layers is reflected in the number of columns of the precoder. For efficient performance, it is important that a transmission rank that matches the channel properties is selected.

### Codebook Based Channel State Information (CSI) Estimation and Feedback

In NR, closed loop MIMO transmission schemes is used where the UE estimates and feeds back the downlink CSI to the gNB. The gNB uses the feedback CSI to transmit DL data to the UE. The CSI consists at least of a transmission rank indicator (RI), a precoding matrix indicator (PMI) and a channel quality indicator(s) (CQI). A codebook of precoding matrices is used by the UE to find out the best match between the estimated downlink channel Hₙ and a precoding matrix in the codebook based on certain criteria, for example, the UE throughput. The channel Hₙ is estimated based on a Non-Zero Power CSI reference signal (NZP CSI-RS) transmitted in the DL.

The CQI/RI/PMI together provide the DL channel state to the UE. This is also referred to as implicit CSI feedback since the estimation of Hₙ is not fed back directly. The CQI/RI/PMI can be wideband or subband depending on which reporting mode is configured.

The RI corresponds to a recommended number of streams that are to be spatially multiplexed and, thus, transmitted in parallel over the DL channel. The PMI identifies a recommended precoding matrix codeword (in a codebook which contains precoders with the same number of rows as the number of CSI-RS ports) for the transmission, which relates to the spatial characteristics of the channel. The CQI represents a recommended transport block size (i.e., code rate) and LTE and New Radio (LNR) supports transmission of one or two simultaneous (on different layers) transmissions of transport blocks (i.e., separately encoded blocks of information) to a UE in a subframe. Thus, there is a relation between a CQI and an SINR of the spatial stream(s) over which the transport block or blocks are transmitted.

Codebooks of up to 32 antenna ports has been defined in NR. Both one dimensional (1D) and two-dimensional (2D) antenna array are supported.

The codebook as designed with a specific antenna numbering in mid (or rather port numbering scheme, where the mapping of antenna port to physical antenna is up to each deployment).

For a given P antenna ports, the precoding codebooks are designed so that the P/2 first antenna ports (e.g., port number 15, 16, 17, 18) should map to a set of co-polarized antennas and the P/2 last antenna ports (e.g., 19, 20, 21, 22) are mapped to another set of co-polarized antennas, with an orthogonal polarization to the first set. This is thus targeting cross-polarized antenna arrays. See FIG. 6 illustrates an example of port numbering for the case of 8 antenna ports. Here, LTE port numbering is shown (15, 16, 17, . . . ) while for NR, the CSI-RS port numbering starts at 3000 (i.e., 3000, 3001, . . . ).

Hence, the codebook principles for the rank 1 case are that a DFT “beam” vector is chosen for each set of P/2 ports and a phase shift with QPSK alphabet is used to co-phase the two sets of antenna ports. A rank 1 codebook is thus constructed as:

$$( \begin{matrix}a \\ a {e}^{i ω}\end{matrix} )$$

where a is a length P/2 vector that forms a beam for the first and second polarizations respectively and ω is a co-phasing scalar that co-phases the two orthogonal polarizations.

### DMRS Configuration

Demodulation reference signals (DMRS) are used for coherent demodulation of physical layer data channels, i.e., PDSCH and PUSCH, as well as of PDCCH. The DMRS is confined to RBs carrying the associated physical layer channel and is mapped on allocated REs of the time-frequency resource grid such that the receiver can efficiently handle time/frequency-selective fading radio channels.

The mapping of DMRS to REs is configurable in both frequency and time domain. There are two mapping types in the frequency domain, i.e., type 1 and type 2. In addition, there are two mapping types in the time domain, i.e., mapping type A and type B, which define the symbol position of the first OFDM symbol containing DMRS within a transmission interval.

The DMRS mapping in time domain can further be single-symbol based or double-symbol based, where the latter means that DMRS is mapped in pairs of two adjacent OFDM symbols. For single symbol based DMRS, a UE can be configured with one, two, three, or four single-symbol DMRS in a slot. For double-symbol based DMRS, a UE can be configured with one or two such double-symbol DMRS in a slot. In scenarios with low Doppler, it may be sufficient to configure front-loaded DMRS only, i.e. one single-symbol DMRS or one double-symbol DMRS, whereas in scenarios with high Doppler additional DMRS will be required in a slot.

FIG. 7 shows an example of type 1 and type 2 front-loaded DMRS where different Code Division Multiplexing (CDM) groups are indicated by different colors and/or patterns. Specifically, FIG. 7 shows single-symbol and double-symbol DMRS and time domain mapping type A with first DMRS in the third OFDM symbol of a transmission interval of 14 symbols. It may be observed from FIG. 7 that type 1 and type 2 differs with respect to both the mapping structure and the number of supported DMRS CDM groups where type 1 support 2 CDM groups and type 2 support 3 CDM groups.

A DMRS antenna port is mapped to the resource elements within one CDM group only. For single-symbol DMRS, two antenna ports can be mapped to each CDM group whereas for double-symbol DMRS four antenna ports can be mapped to each CDM group. Thus, for DMRS type 1 the maximum number of DMRS ports is four for a single-symbol based DMRS configuration and eight for double-symbol based DMRS configuration. For DMRS type 2, the maximum number of DMRS ports is six for a single-symbol based DMRS configuration and twelve for double-symbol based DMRS configuration.

An orthogonal cover code (OCC) of length 2 (i. e., [+1,+1] or [+1,−1]) is used to separate antenna ports mapped in the same two REs within a CDM group. The OCC is applied in frequency domain (FD) as well as in time domain (TD) when double-symbol DMRS is configured. This is illustrated in FIG. 7 for CDM group 0.

In NR Rel-15, the mapping of a PDSCH DMRS sequence r(m), m=0, 1, . . . on antenna port p_{□} and subcarrier k in OFDM symbol l for the numerology index μ is specified in 3GPP TS38.211 as:

$${a}_{k , l}^{( p , μ )} = {β}_{PDSCH}^{DMRS} {w}_{f} ( {k}^{′} ) {w}_{t} ( {l}^{′} ) r ( 2 n + {k}^{′} )$$

$$k = \{ \begin{matrix}4 n + 2 {k}^{′} + Δ Configuration type 1 \\ 6 n + {k}^{′} + Δ Configuration type 2\end{matrix}$$

$${k}^{′} = 0 , 1$$

$$l = \overline{l} + {l}^{′}$$

$$n = 0 , 1 , …$$

where w_{f}(k′) represents a frequency domain length 2 OCC code and wₜ(l′) represents a time domain length 2 OCC code. Table 1 and Table 2 show the PDSCH DMRS mapping parameters for configuration type 1 and type 2, respectively.

TABLE 1
PDSCH DMRS mapping parameters for configuration type 1.

| | | |
|---|---|---|
| CDM group | w_{f} (k′) | wₜ (l′) |

| p | λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DMRS mapping parameters for configuration type 2.

| | | |
|---|---|---|
| CDM | w_{f} (k′) | wₜ (l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

For PDSCH mapping type A, DMRS mapping is relative to slot boundary. That is, the first front-loaded DMRS symbol in DMRS mapping type A is in either the 3^{rd} or 4^{th} symbol of the slot. In addition to the front-loaded DMRS, type A DMRS mapping can consist of up to 3 additional DMRS.

FIG. 8 illustrates some examples of DMRS configurations for PDSCH mapping type A. FIG. 8 assumes that the PDSCH duration is the full slot. If the scheduled PDSCH duration is shorter than the full slot, the positions of the DMRS changes according to the specification 3GPP TS 38.211. It is noted that a PDSCH length of 14 symbols is assumed in the examples of FIG. 8.

For PDSCH mapping type B, DMRS mapping is relative to transmission start. That is, the first DMRS symbol in DMRS mapping type B is in the first symbol in which type B PDSCH starts. FIG. 9 illustrates examples of DMRS configurations for mapping type B.

The same DMRS design for PDSCH is also applicable for PUSCH when transform precoding is not enabled, where the sequence r(m) shall be mapped to the intermediate quantity

$${\tilde{a}}_{k , l}^{( {\tilde{p}}_{j} , μ )}$$

for DMRS port \tilde{p}ⱼ according to

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ Configuration type 1 \\ 6 n + {k}^{′} + Δ Configuration type 2\end{matrix}$$

$${k}^{′} = 0 , 1$$

$$l = \overline{l} + {l}^{′}$$

$$n = 0 , 1 , …$$

$$j = 0 , 1 , … , v - 1$$

where w_{f}(k′), wₜ(l′), and Δ are given by Tables 3 and 4, which correspond to Tables 6.4.1.1.3-1 and 6.4.1.1.3-2 in 3GPP TS 38.211, and v is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

shall be precoded, multiplied with the amplitude scaling factor

$${β}_{PUSCH}^{DMRS}$$

in order to conform to the transmit power specified in clause 6.2.2 of TS 38.214, and mapped to physical resources according to

$$[ \begin{matrix}{a}_{k , l}^{{p}_{0} , μ} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{( {\tilde{p}}_{0} , μ )} \\ ⋮ \\ {\tilde{a}}_{k , l}^{( {\tilde{p}}_{v - 1} , μ )}\end{matrix} ]$$

where
   the precoding matrix W is given by clause 6.3.1.5 of 3GPP TS 38.211,
   {p_{0, . . . ,} p_{ρ-1}} is a set of physical antenna ports used for transmitting the PUSCH, and
   {p_{0, . . . ,} p_{υ-1}} is a set of DMRS ports for the PUSCH;

TABLE 3
Parameters for PUSCH DMRS configuration type 1.

| | | |
|---|---|---|
| CDM group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 4
Parameters for PUSCH DMRS configuration type 2.

| | | |
|---|---|---|
| CDM group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

### DMRS Ports Signaling

DMRS port(s) for a PDSCH or a PUSCH are signaled in the corresponding scheduling DCI. In addition to the DMRS ports, the number of CDM groups that are not allocated for PDSCH or PUSCH and the number of front-loaded DMRS symbols are dynamically signaled in the DCI.

In PUSCH scheduling, the number of layers is indicated separately from DMRS ports signaling in the DCI. While for PDSCH scheduling, the number of layers and DMRS ports are signaled jointly in the DCI.

An “antenna port(s)” bit field in DCI is used the purpose. An example for type 1 DMRS with rank=1 and up to two maximum number of front-loaded DMRS OFDM symbols for PUSCH is shown in Tables 5 and 6, which correspond to Table 7.3.1.1.2-12 and Table 7.3.1.1.2-13 of 3GPP TS 38.212. Here, 4 bits are used. Note that DMRS type and maximum number of front-loaded DMRS symbols are semi-statically configured by RRC.

TABLE 5
Antenna port(s), transform precoder is disabled, dmrs-Type = 1,
maxLength = 2, rank = 1 (from TS38.212 of 3gpp)

| | Number of DMRS CDM | DMRS | Number of front-load |
|---|---|---|---|
| Value | group(s) without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 6
Antenna port(s), transform precoder is disabled,
dmrs-Type = 1, maxLength = 2, rank = 2

| | Number of DMRS CDM | DMRS | Number of front- |
|---|---|---|---|
| Value | group(s) without data | port(s) | load symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Another example for type 1 DMRS with up to two maximum number of front-loaded DMRS OFDM symbols for PDSCH is shown in Table 7, which corresponds to Table 7.3.1.2.2-2 of 3GPP TS 38.212.

TABLE 7
Antenna port(s) (1000 + DMRS port), dmrs-Type =
1, maxLength = 2 (from TS38.212 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number | | |
| | DMRS | | | | of DMRS | | |
| | CDM | | Number | | CDM | | |
| | group(s) | | of front- | | group(s) | | Number of |
| | without | DMRS | load | | without | | front-load |
| Value | data | port(s) | symbols | Value | data | DMRS port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

There currently exist certain challenge(s), however. For example, measuring and reporting CQI based on PDSCH DM-RS has been discussed in 3GPP for several years. The idea is that the UE uses the DM-RS associated with a UE specifically precoded and transmitted PDSCH not only for demodulation but also to estimate CQI. Then, the UE can report a CQI that better reflects the “true” performance of the received PDSCH taking into account the transmit precoding and possibly also interference on the DM-RS.

Similarly, measurements related to uplink channel quality based on PUSCH DM-RS are commonly used. The idea is that the network uses the DM-RS associated a transmitted PUSCH not only for demodulation but also to estimate channel quality or “uplink CQI.” The term uplink CQI may be considered a misnomer since there is no UPLINK CQI for the uplink, but the term is used here to denote channel quality estimated for the uplink used for subsequent uplink scheduling of PUSCH or PUCCH. Then the network can estimate a UPLINK CQI that better reflects the “true” performance of the received PUSCH taking into account the transmit precoding and possibly also interference on the DM-RS (instead of the usual use of SRS for such measurements).

The problem with these approaches is that it is not possible to estimate a preferred rank and report a preferred rank larger than R, since if the PDSCH or PUSCH has R layers, then the associated UPLINK CQI measurement or CQI report (respectively) is of rank R, while the optimal rank could be rank R+1 or R−1 for example. If this type of CQI reporting or Uplink CQI measurement is used continuously, it will lead to that the UE is scheduled PDSCH or PUSCH with suboptimal rank simply because the network scheduler is unaware of whether other ranks are better.

### SUMMARY

Certain aspects of the disclosure and their embodiments may provide solutions to these or other challenges. For example, methods and systems are provided that enable the number of Reference Signal (RS) ports, Q, for a PDSCH or PUSCH transmission to be different from the number of PDSCH or PUSCH layers, R, respectively. In a particular embodiment, Q is higher layer configured or fixed in specifications. In another particular embodiment, Q is dynamically indicated along with R.

According to certain embodiments, a method by a UE is provided for extending RS for a downlink RS transmission and/or an uplink RS transmission. The method includes receiving from a network node, a scheduling assignment associated with the downlink RS transmission or the uplink RS transmission. The scheduling assignment includes an indication of a transmission rank associated with a first number of ports, R. The scheduling assignment also includes an indication to perform, for the downlink RS transmission, at least one measurement on a second number of ports, Q, or an indication to transmit the uplink RS transmission on a second number of ports, Q. The UE transmits, to the network node, a measurement report based on the second number of ports, Q or the uplink RS transmission on the second number of ports, Q. Data is mapped to the first number of ports, R.

According to certain embodiments, a UE for extending RS for a downlink RS transmission and/or an uplink RS transmission is configured to receive from a network node, a scheduling assignment associated with the downlink RS transmission or the uplink RS transmission. The scheduling assignment includes an indication of a transmission rank associated with a first number of ports, R. The scheduling assignment also includes an indication to perform, for the downlink RS transmission, at least one measurement on a second number of ports, Q, or an indication to transmit the uplink RS transmission on a second number of ports, Q. The UE is configured to transmit, to the network node, a measurement report based on the second number of ports, Q or the uplink RS transmission on the second number of ports, Q. Data is mapped to the first number of ports, R.

According to certain embodiments, a method by a network node for extending RS for measurements is provided. The method includes transmitting, to a UE, a scheduling assignment associated with a downlink RS transmission from the network node or an uplink RS transmission from the UE. The scheduling assignment includes an indication of a transmission rank associated with a first number of ports, R. The scheduling assignment includes an indication to receive the downlink RS transmission on a second number of ports, Q, or an indication to transmit the uplink RS transmission, on the second number of ports, Q. The network node transmits, to the UE, the downlink RS transmission on the second number of ports, Q, or receives, from the UE, the uplink RS transmission on the second number of ports, Q. Data is mapped to the first number of ports, R.

According to certain embodiments, a network node for extending RS for measurements is configured to transmit, to a UE, a scheduling assignment associated with a downlink RS transmission from the network node or an uplink RS transmission from the UE. The scheduling assignment includes an indication of a transmission rank associated with a first number of ports, R. The scheduling assignment includes an indication to receive the downlink RS transmission on a second number of ports, Q, or an indication to transmit the uplink RS transmission, on the second number of ports, Q. The network node is configured to transmit, to the UE, the downlink RS transmission on the second number of ports, Q, or receive, from the UE, the uplink RS transmission on the second number of ports, Q. Data is mapped to the first number of ports, R.

Certain embodiments may provide one or more of the following technical advantage(s). For example, certain embodiments may provide a technical advantage of allowing the base station to transmit a “higher rank,” RS transmission (a larger number of DMRS ports) than the actual PDSCH transmission (assuming one DMRS port per layer is used). Thus, Q>R is enabled. By doing this, certain embodiments resolve the problem of “rank blindness” of DM-RS based CQI reporting as to whether a higher rank transmission would actually be beneficial to the UE.

As another example, certain embodiments may provide a technical advantage of avoiding the use of CSI-RS based measurements for rank reporting since rank can be estimated on the DM-RS. Thus, a technical advantage may be the reduction of overhead in the system since CSI-RS transmission and triggering consumes resources. As still another example, certain embodiments may provide a technical advantage of resolving the rank blindness problem of DM-RS based CQI reporting.

As still another example, certain embodiments may provide a technical advantage of allowing the UE to transmit a “higher rank” RS transmission (a larger number of DMRS ports) than the actual PUSCH transmission (assuming one DMRS port per layer is used). Thus, Q>R is enabled. By doing this, certain embodiments resolve the problem of “rank blindness” as to whether a higher rank transmission would actually be beneficial to the UE.

As another example, certain embodiments may provide a technical advantage of describing how the UE should precode and transmit DMRS associated with the remaining Q-R layers in the uplink when Q>R. Thus, a precoding matrix codebook for Q ports is introduced where the R first columns of the precoding matrix are used for data transmissions while the Q-R last columns are only used by the network for measurements and “rank probing.”

As still another example, certain embodiments may provide a technical advantage of avoiding the use of SRS based measurements for rank estimation since rank can be estimated on the DM-RS. This reduces the overhead in the system since SRS transmission and triggering consumes resources. As such certain embodiments resolve the rank blindness problem of DM-RS based UPLINK CQI measurements.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example NR time domain structure with a 14-symbol slot and 15 KHz subcarrier spacing;

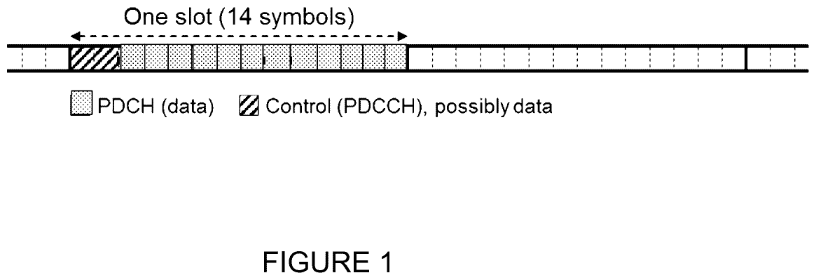

FIG. 2 illustrates the basic NR physical time-frequency resource grid;

FIG. 3 illustrates the basic LTE and NR DL physical resource as a time-frequency grid;

FIG. 4 illustrates the NR time domain structure;

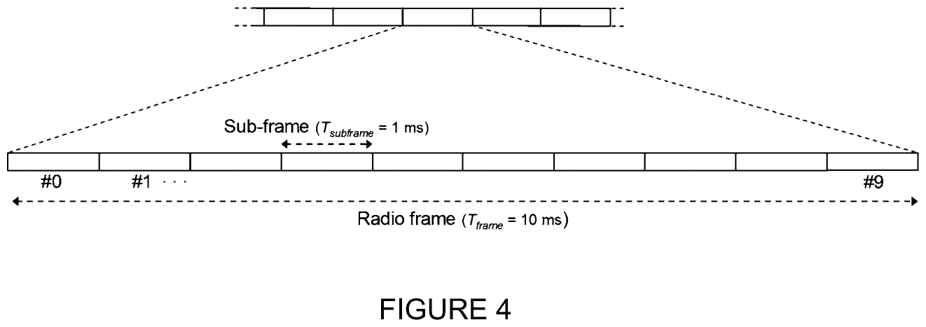

FIG. 5 illustrates a transmission structure of precoded spatial multiplexing mode in NR;

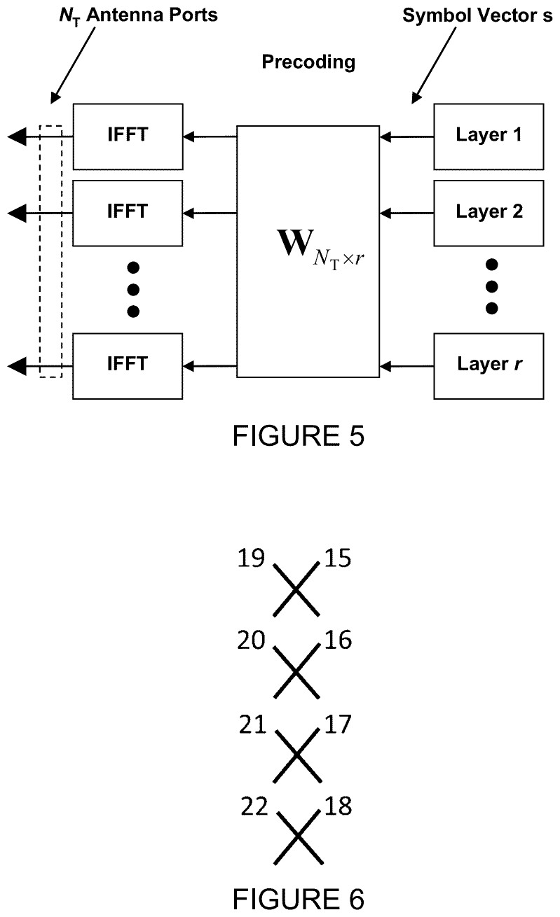

FIG. 6 illustrates an example of port numbering for the case of 8 antenna ports;

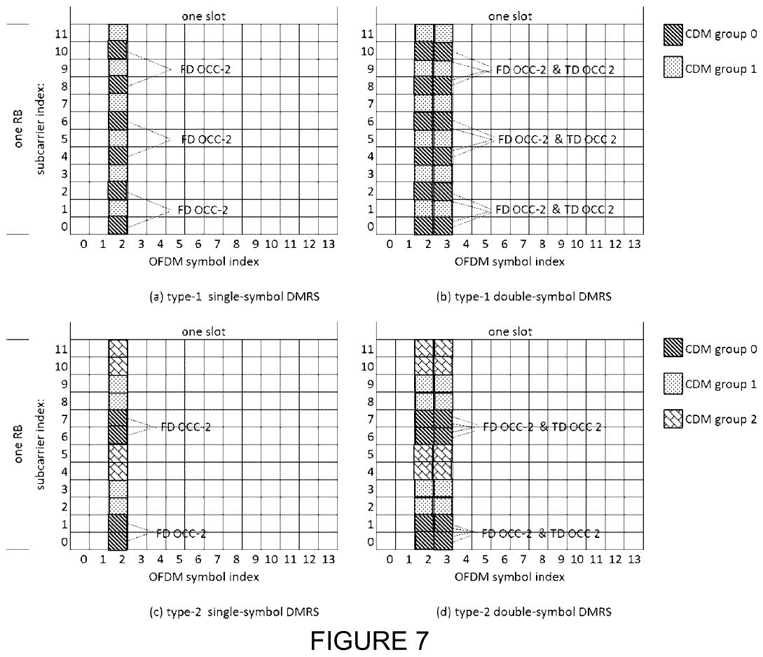

FIG. 7 illustrates an example of type 1 and type 2 front-loaded DMRS where different CDM groups are indicated by different colors and/or patterns;

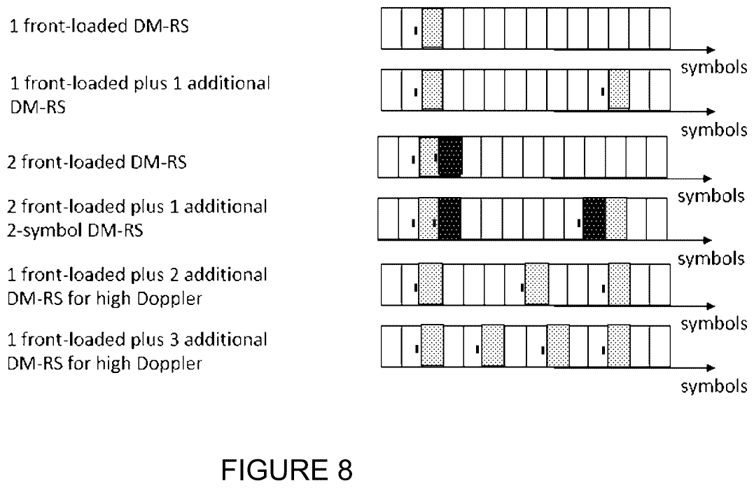

FIG. 8 illustrates examples of DMRS configurations for PDSCH mapping type A;

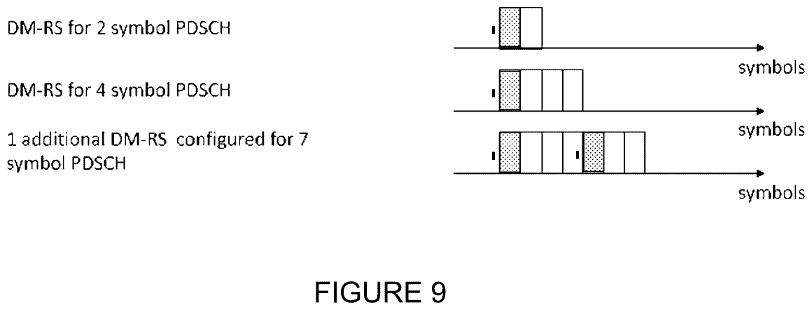

FIG. 9 illustrates examples of DMRS configurations for PDSCH mapping type B;

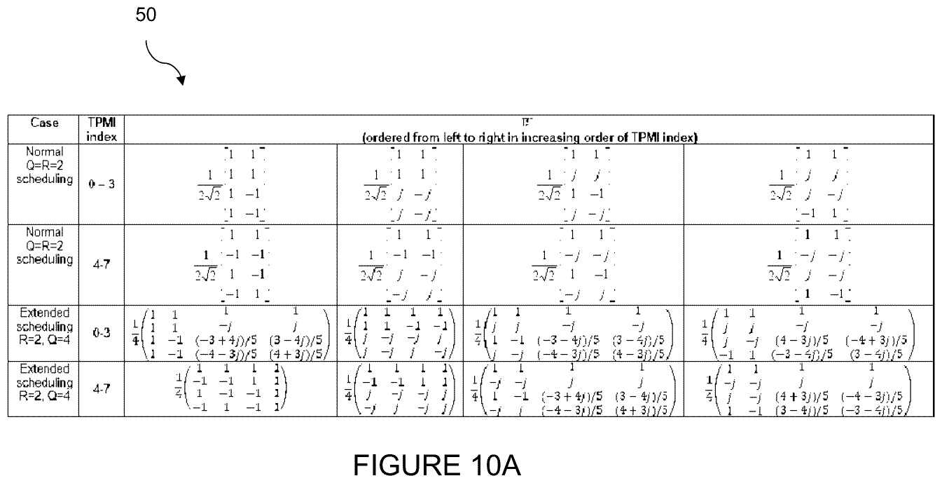

FIGS. 10A and 10B illustrate example tables for a precoder codebook, according to certain embodiments;

FIG. 11 illustrates an example communication system, according to certain embodiments;

FIG. 12 illustrates an example UE, according to certain embodiments;

FIG. 13 illustrates an example network node, according to certain embodiments;

FIG. 14 illustrates a block diagram of a host, according to certain embodiments;

FIG. 15 illustrates a virtualization environment in which functions implemented by some embodiments may be virtualized, according to certain embodiments;

FIG. 16 illustrates a host communicating via a network node with a UE over a partially wireless connection, according to certain embodiments;

FIG. 17 illustrates an example method by a UE for utilizing dynamic density RS patterns, according to certain embodiments;

FIG. 18 illustrates another example method by a UE for utilizing dynamic density RS patterns, according to certain embodiments;

FIG. 19 illustrates an example method by a network node for utilizing dynamic density RS patterns, according to certain embodiments; and

FIG. 20 illustrates another example method by a network node for utilizing dynamic density RS patterns, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g., in a gNB), Distributed Unit (e.g., in a gNB), Baseband Unit, Centralized Baseband, C-RAN, access point (AP), etc.

It is noted that terminology used here, such as gNB and UE, should be considering non-limiting and, in particular, does not imply a certain hierarchical relation between the two. In general, “gNB” could be considered as device 1 and “UE” device 2, and these two devices communicate with each other over some radio channel. Alternatively, other terminology such as “gNodeB” can be used in place of “gNB” in different communication systems. Herein, we also focus on wireless transmissions in the DL, but methods, systems, and embodiments disclosed herein are equally applicable in the UL.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

According to certain embodiments, methods and systems are provided that enable the number of Reference Signal (RS) ports, Q, for a PDSCH or PUSCH transmission to be different from the number of PDSCH or PUSCH layers, R, respectively. In a particular embodiment, Q is higher layer configured or fixed in specifications. In another particular embodiment, Q is dynamically indicated along with R.

With a dynamically indication of Q=R and Q>R, it is possible for the network to switch between “legacy” behavior Q=R and the rank probing (Q>R) report from the UE. If Q=R, then no Rank report is associated with UPLINK CQI, while if Q>R, then both rank and UPLINK CQI is reported from the UE to the network.

### Downlink Transmissions

A PDSCH transmission of rank R has R DM-RS ports, one per PDSCH layer. According to certain embodiments, the PDSCH transmission can have Q>R DMRS ports, where Q-R ports are not associated with any PDSCH layer and are thus representing hypothetical layers so the UE can evaluate whether the preferred rank for a subsequent transmission should be different from R. For example, in a particular embodiment, the R lowest numbered ports among the Q ports are used for PDSCH demodulation while the Q-R highest numbered ports are only used for measurements.

Certain embodiments enable the UE to report a preferred rank between 0 and Q. This is in contrast to previous techniques where any CQI reporting based on DMRS could only report rank between 1 and R.

In a particular embodiment, the preferred rank is only reported by the UE if Q>R.

In another particular embodiment, the UE is configured to always report the preferred rank based on the Q DMRS ports, irrespective of how many PDSCH layers are transmitted. This includes a scenario/configuration where Q=R.

In still another embodiment, the UE is separately indicated if the preferred rank should be reported, irrespective of the values of Q and R.

In a particular embodiment, Q is higher layer configured or fixed in specifications. In another particular embodiment, Q is dynamically indicated along with R.

In a particular embodiment, the Q-R ports that are only used for CSI measurement has a lower RS density (in time and/or frequency) compared to the Reports that are used for PDSCH demodulation since these ports don't need the highest quality of channel estimation performance.

In a particular embodiment, a comb 4 DMRS is used for the Q-R ports while a comb 2 DMRS is used for the R ports. In another particular embodiment, the Q-R ports used for only measurements are only present in one of the DMRS OFDM symbols in the PDSCH duration, while the R ports used for demodulation are present in multiple OFDM symbols. This embodiment may be utilized, since for CSI measurement, it is often only necessary to measure in a single OFDM symbol as the time variability of the channel is not part of the CSI report (typically).

In a particular example embodiment, 2-layer data is assumed:
Port 0 and 1 used to demodulate the two PDSCH layers respectively, and for estimation of rank and CQI
Port 2 and 3 used for estimation of rank and CQI only

The specification restricts the network so that the UE is not expected to receive a rank R transmission that is higher than the number of indicated RS ports Q since in this case, not all layers will have an associated port.

If Q>R, (depending on the DMRS structure), then it may be that the power for a DMRS port is lower than the power of an associated PDSCH layer. Hence, the PDSCH to DMRS EPRE ratio depends not only on the rank R but also on the total number of transmitted RS ports Q.

In a further particular embodiment, the DCI can schedule a PDSCH which doesn't carry any payload data. Thus, only the Q DMRS ports are transmitted (i.e. R=0). The DM-RS in this case will act as an aperiodic CSI-RS in NR, although using the DM-RS structure of the RS.

Depending on the content of the DCI that schedules the UE for DL transmission, there could be these different cases:
Aperiodic trigger case (with no PDSCH is transmitted),
   The same DCI as a PDSCH assignment can be reused where the PDSCH payload is indicated to be zero or rank is zero or in some other way of indicating in DCI that the transmission contains no data, only DMRS. Alternatively, a separate DCI message may be used.
   The RS BW is given by the frequency domain resource allocation (FDRA) field (same interpretation as if PDSCH was scheduled).
   The RS time duration for the CSI-RS is given by the time domain resource allocation (TDRA) field. In a particular embodiment, a new interpretation is needed.
   Note that this may be a slightly different as compared to item 3 below when TBS=0, then the FDRA and possibly also TDRA are used to set the parameters for the RS transmission, thereby allowing for a fully flexible and dynamic allocation for an aperiodic RS. Note that in LRTE and NR, the CSI-RS parameters are given by an RRC configuration (per CSI trigger codepoint in DCI)
PDSCH is scheduled with rank R and the antenna port indication field points to the DMRS antenna port indication table, to a row that has Q=R DMRS ports. In a particular embodiment, the UE is configured to report rank even where Q=R, though the rank is upper bounded by R and not Q.
   A normal PDSCH transmission of rank R. The receiver can, if configured by the network, use these DMRS as if it was a CSI-RS measurement and report CQI and a rank between 1 and R.
   This can be seen as the baseline and what is new is actually that the DMRS is used as a CSI-RS and there is an associated CSI report. Certain similar ideas have been discussed in 3GPP, known as DMRS based CSI reporting.
      i. The UE reports a CSI reporting using the R ports, i.e. it can recommend a rank to the network in the CSI report that is in the range 1, . . . , R.
      ii. Note that this suffers from rank blindness issue which is resolved by certain embodiments disclosed herein, unless R is the maximum rank the UE can be scheduled with. Rank blindness means that R+1 could for instance be a better rank for the UE reception.
PDSCH is scheduled with rank R and the antenna port indication field points to the DMRS antenna port indication table, to a row that has Q>R DMRS ports.
   The R ports are used for R layer PDSCH demodulation and rank estimation.
   The residual Q-R RS ports are only used for rank estimation, e.g. to determine whether a rank>R is more beneficial for a subsequent scheduling of the UE for PDSCH.
   The UE reports rank and CQI using the Q ports, i.e. it can recommend a rank to the network in the CSI report that is in the range 1, . . . , Q, where Q>R and thereby the “rank blindness” problem is resolved.

In various particular embodiments, the DCI may need to have one or more or all of the following information:
In a particular embodiment, the DCI indicates rank R as a separate field (rank is not given by the antenna port indication table as in LTE and NR where indicating Q ports automatically means rank Q transmission), to decouple PDSCH rank R from #RS ports Q.
In a particular embodiment, Q and R are jointly encoded (potentially useful as “useless combinations of Q and R, e.g., Q<R can be skipped). Thus, Q and R may not be included in separate fields of the DCI so long as different values for Q and R are conveyed.
In another particular embodiment, a codepoint in DCI indicates Q and R jointly, so that “impossible” combinations of Q and R cannot be indicated (such as Q<R)
To support case 1 above, TB size=zero is indicated by, for example, an entry in the TBS field (or in the MCS field) or by a dedicated information bit in the DCI or by some combination of the header and payload of the DCI.

The report of the rank and CQI is in one embodiment transmitted from the UE together with the HARQ-ACK bits associated with the PDSCH for which the UE measured CQI or CSI+rank using the R or Q DMRS ports respectively. Alternatively the rank and/or CQI report is triggered in a separate CSI report on PUCCH or PUSCH.

### Uplink Transmissions

A PUSCH transmission of rank R has R DM-RS ports, one per PUSCH layer.

According to certain embodiments, the PUSCH transmission can have Q>R DMRS ports, where Q-R ports are not associated with any PUSCH layer and are thus representing hypothetical layers so the UE can evaluate whether the preferred rank for a subsequent transmission should be different from R.

For example, in a particular embodiment, the R lowest numbered ports among the Q ports are used for PUSCH demodulation while the Q-R highest numbered ports are only used for measurements.

In a particular embodiment, Q is higher layer configured or fixed in specifications. In another particular embodiment, Q is dynamically indicated along with R. With a dynamically indication of Q=R and Q>R, it is possible for the network to switch between “legacy” behavior Q=R and the rank probing (Q>R) measurement of DMRS from the UE. If Q=R, then no Rank measurement (at least not for higher rank than R) is associated with UPLINK CQI, while if Q>R, then both rank and UPLINK CQI can be measured by the network.

In a particular embodiment, the Q-R ports that are only used for CSI measurement has a lower RS density (in time and/or frequency) compared to the R ports that are used for PUSCH demodulation since these ports don't need the highest quality of channel estimation performance. In a particular embodiment, a comb 4 DMRS is used for the Q-R ports while a comb 2 DMRS is used for the R ports.

In another particular embodiment, the Q-R ports used for only measurements are only present in one of the DMRS OFDM symbols in the PUSCH duration, while the R ports used for demodulation are present in multiple OFDM symbols.

In a particular example embodiment, 2-layer data is assumed:
Port 0 and 1 used to demodulate the two PUSCH layers respectively, and as SRS
Port 2 and 3 used as CSI-RS only

The specification restricts the network so that the UE is not expected to transmit a rank R transmission that is higher than the number of indicated RS ports Q since in this case, not all layers will have an associated port.

If Q>R, (depending on the DMRS structure), then it may be that the power for a DMRS port is lower than the power of an associated PUSCH layer. Hence, the PUSCH to DMRS EPRE ratio depends not only on the rank R but also on the total number of transmitted RS ports Q.

In a further particular embodiment, the DCI can schedule a PUSCH which doesn't carry any payload data. Thus, only the Q DMRS ports are transmitted (i.e. R=0). The DM-RS in this case will act as an aperiodic SRS in NR, although using the DM-RS structure of the RS.

Depending on the content of the DCI that schedules the UE for UL transmission, there could be these different cases:
Aperiodic trigger SRS case (with no PUSCH is transmitted), in this case, the Antenna port indication field in DCI points to the SRS antenna port indication table.
   The same DCI as a PUSCH assignment can be reused where the PUSCH payload is indicated to be zero or rank is zero or in some other way of indicating in DCI that the transmission contains no data, only DMRS. Alternatively, a separate DCI message may be used to transmit the transmit the indication relating to the number of Q ports.
   The SRS BW is given by the frequency domain resource allocation (FDRA) field (same interpretation as if PUSCH was scheduled).
   The time duration for the SRS is given by the time domain resource allocation (TDRA) field.
   Note that this may be a slightly different as compared to item 3 below when TBS=0, then the FDRA and possibly also TDRA are used to set the parameters for the SRS transmission, thereby allowing for a fully flexible and dynamic allocation for an aperiodic SRS. Note that in LTE and NR, the SRS parameters are given by an RRC configuration (per SRS trigger codepoint in DCI)
PUSCH is scheduled with rank R and the antenna port indication field points to the DMRS antenna port indication table, to a row that has Q=R DMRS ports.
   A normal PUSCH transmission of rank R. The receiver can, if configured by the network, use these DMRS as an SRS measurement as well but there is no rank estimation for more than R layers, only UPLINK CQI estimation.
   This can be seen as the baseline and what is new is actually that the DMRS is used as a SRS and there is an associated Uplink CQI measurement.
PUSCH is scheduled with rank R and the antenna port indication field points to the DMRS antenna port indication table, to a row that has Q>R DMRS ports.
   The R ports are used for R layer PUSCH demodulation (i.e., a DMRS and possible also as an SRS).
   The residual Q-R RS ports are only used for measurement (i.e., an SRS), e.g., to determine whether a rank>R is more beneficial for a subsequent scheduling of the UE for PUSCH.

In various particular embodiments, the DCI may need to have one or more or all of the following information:
In a particular embodiment, the DCI indicates rank R as a separate field (rank is not given by the antenna port indication table as in LTE and NR where indicating Q ports automatically means rank Q transmission), to decouple PUSCH rank R from #RS ports Q.
In a particular embodiment, Q and R are jointly encoded (i.e., DCI indicates Q and R jointly) so that “impossible” combinations of Q and R cannot be indicated (such as Q<R).
To support case 1 above, TB size=zero is indicated by, for example, an entry in the TBS field (or in the MCS field) or by a dedicated information bit in the DCI or by some combination of the header and payload of the DCI.

A technical advantage of certain of these embodiments is that the measurement on DMRS can be utilized for link adaptation in a better way. Additionally, the problem of being stuck with the same rank as the latest PUSCH is avoided and the need for triggering SRS only type of measurements is reduced (even if these are supported as well using the empty TBS size).

### Precoder Codebook

When Q>R, there is a need to define the precoding vector for the Q-R DMRS ports in the UL.

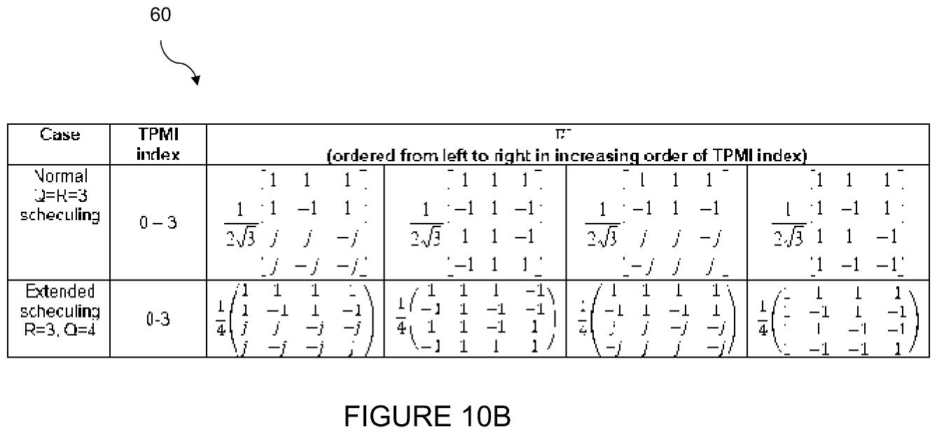

In case Q=R is indicated from the network to the UE, then the UE shall transmit a rank R=Q PUSCH using the indicated UL MIMO precoder. This is denoted as “normal scheduling” in Tables 50 and 60 illustrated in FIGS. 10A and 10B, respectively. While if Q>R is indicated, this is denoted as “extended scheduling” in Tables 50 and 60. For example, the rows with R=2, Q=4 indicates a rank 2 PUSCH transmission using the two first columns of the indicated precoder (by the TPMI index) along with the two associated DM-RS ports. The third and fourth column in the precoding matrix indicated by the TPMI is used for DM-RS precoding for the third and fourth DM-RS port. These precoders represent the hypothetical third and fourth layer for a PUSCH transmission in case of a rank 3 and rank 4 transmission would have been scheduled so the network can simultaneously receive a PUSCH of rank R and assess the quality of a transmission of a different rank than R.

The additional Q-R columns are obtained by an orthonormal expansion of the R first columns in order to maintain the Hermitian property of the precoding matrix.

### Power Scaling of RS Vs PDSCH/PUSCH Layers

According to previous methods and techniques, the effective power per resource element (EPRE) ratio between an DMRS port and the associated PDSCH/PUSCH layer is 0 dB. Thus, this holds if there are Q=R DMRS ports.

In addition, if the PDSCH/PUSCH is not mapped in DMRS symbol, then the DMRS power can be boosted to DMRS/PDSCH/PUSCH EPRE=10*log 10(num_comb) dB, due to only 1/num_comb subcarriers are used by DMRS and the remaining subcarriers (resource elements) are empty. Thus, there is a power transfer from empty subcarriers to used subcarriers.

If the Q DMRS ports are multiplexed in the same OFDM symbol, then the power for a DMRS port relative to the associated PDSCH/PUSCH layer will reduce when Q>R since the available power in an OFDM symbol is split among Q ports. The receiver needs to know this since for higher order modulation such as 16QAM or 64QAM, the EPRE power ratio between DMRS and PDSCH/PUSCH layer is important for correct demodulation.

Thus, the power ratio is described as follows for TDM between DMRS and PDSCH/PUSCH (it is assumed that at least when Q>R, then TDM is used):

$$D MRS / PDSCH / PUSCH EPRE = 10 * log 10 ( num\_comb ) - log 10 ( Q / R )$$

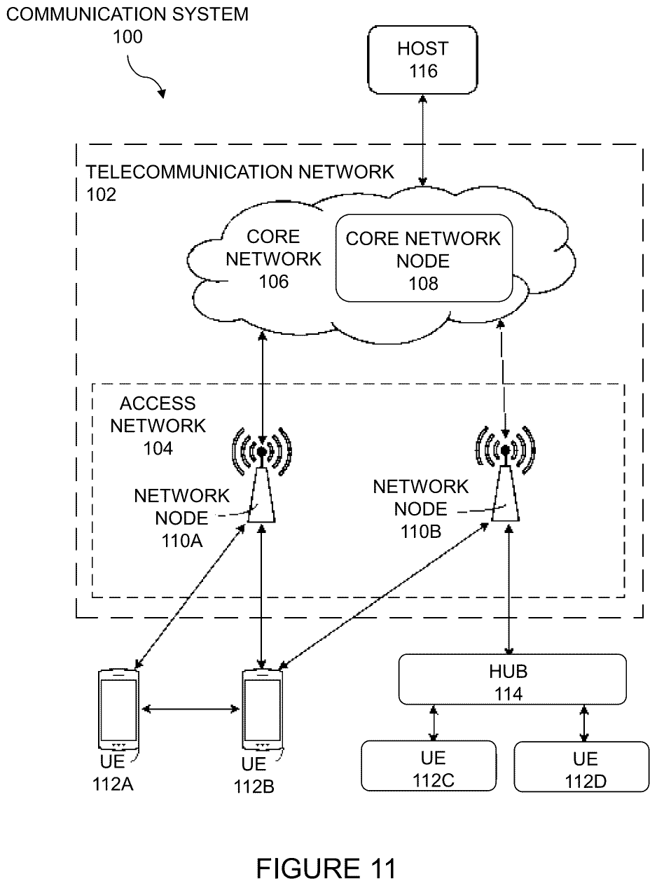

FIG. 11 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

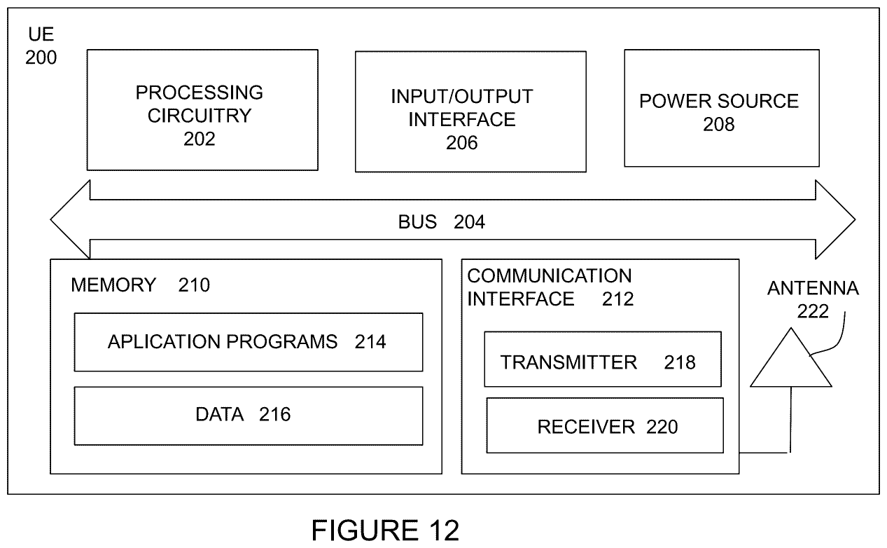

FIG. 12 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

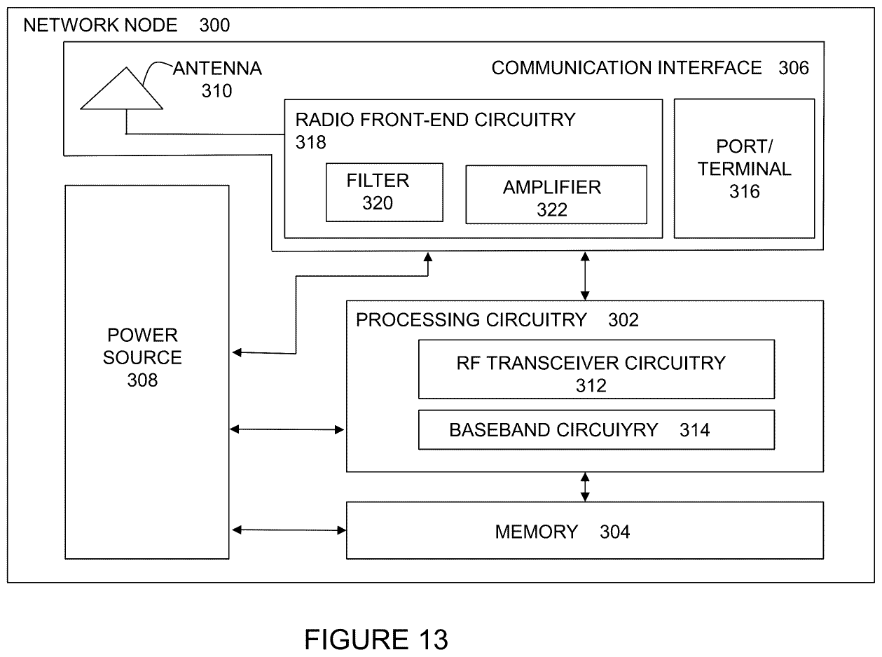

FIG. 13 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 13 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

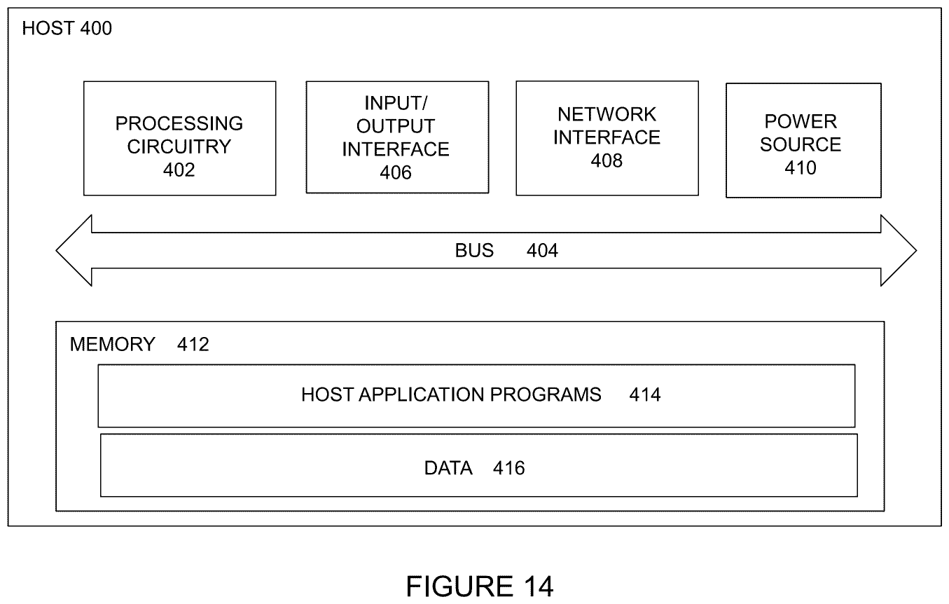

FIG. 14 is a block diagram of a host 400, which may be an embodiment of the host 116 of FIG. 11, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

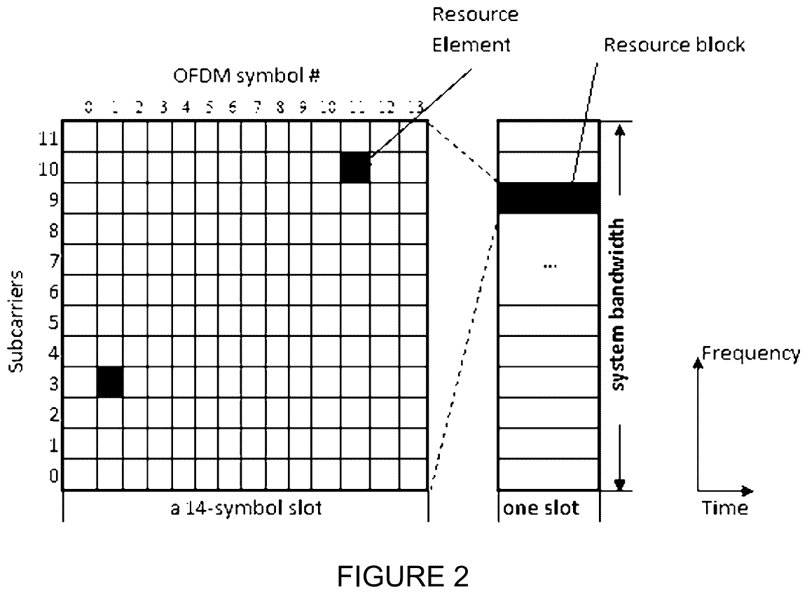

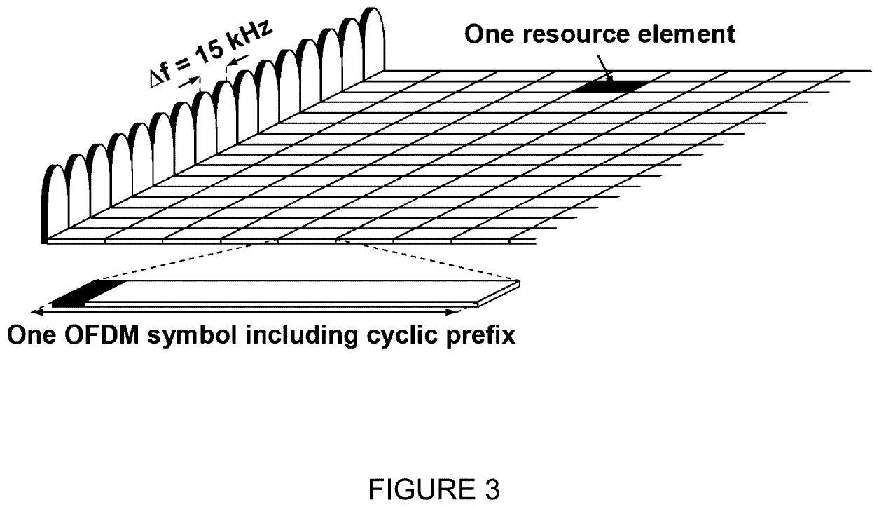

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top (OTT) services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

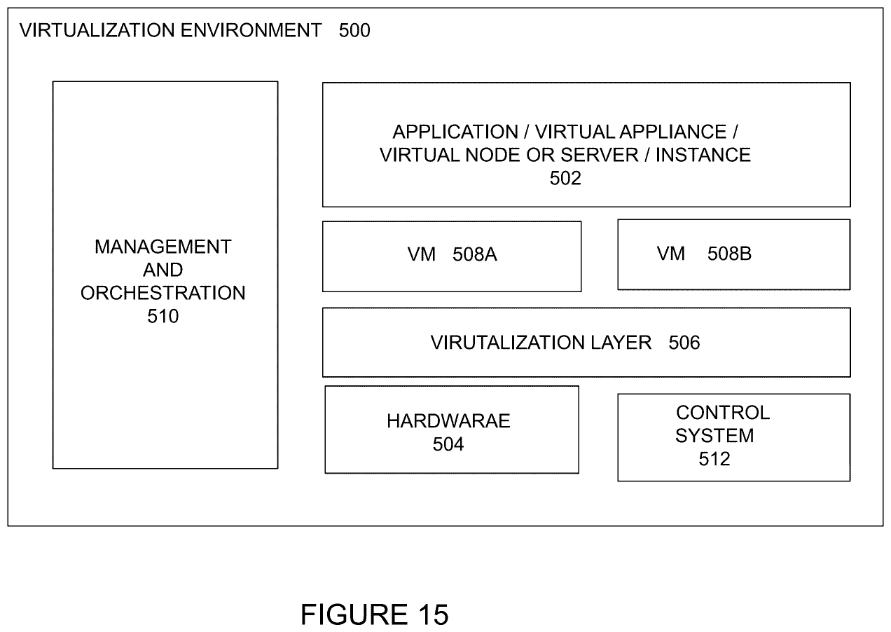

FIG. 15 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

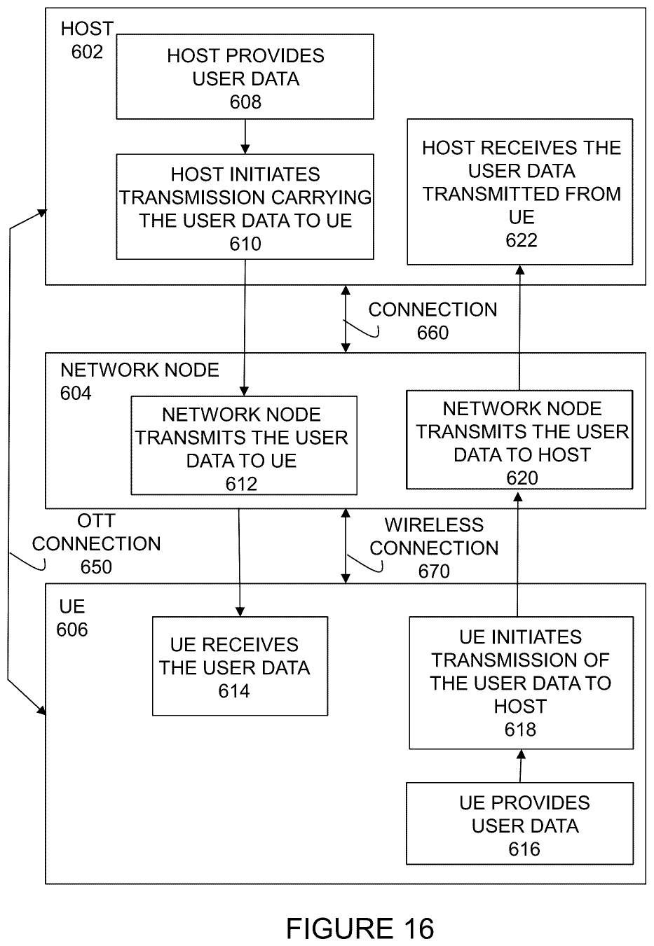

FIG. 16 shows a communication diagram of a host 602 communicating via a network node 604 with a UE 606 over a partially wireless connection in accordance with some embodiments.

Example implementations, in accordance with various embodiments, of the UE (such as a UE 112a of FIG. 11 and/or UE 200 of FIG. 12), network node (such as network node 110a of FIG. 11 and/or network node 300 of FIG. 13), and host (such as host 116 of FIG. 11 and/or host 400 of FIG. 14) discussed in the preceding paragraphs will now be described with reference to FIG. 16.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an OTT connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 11) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

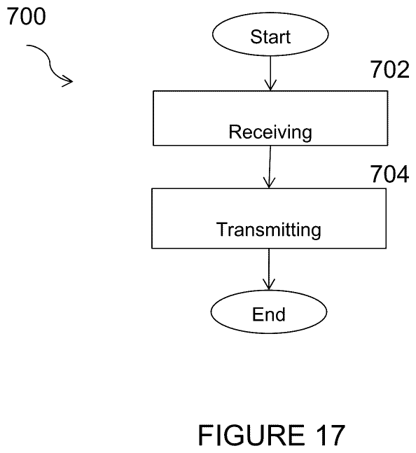

FIG. 17 illustrates an example method 700 by a UE for extending RS for measurements for a downlink RS transmission, according to certain embodiments. In the illustrated embodiment, the method includes a receiving step at 702 and a transmitting step at 704.

For example, according to certain embodiments relating to the downlink, at step 702, the UE may receive, from a network node, a scheduling assignment associated with the downlink RS transmission. In a particular embodiment, the scheduling assignment includes an indication of a transmission rank associated with a first number of ports, R, and an indication to perform at least one measurement on a second number of ports, Q. At step 704, for example, the UE may transmit, to the network node, a measurement report based on the second number of ports, Q.

As another example, according to certain embodiments relating to the uplink, at step 702, the UE may receive, from a network node, a scheduling assignment associated with the uplink RS transmission. The scheduling assignment includes an indication of a transmission rank associated with a first number of ports, R, and an indication to transmit the uplink RS transmission on a second number of ports, Q. At step 704, for example, the UE may transmit, to the network node, the uplink RS transmission on the second number of ports, Q. In the uplink RS transmission, data is mapped only to the first number of ports, R.

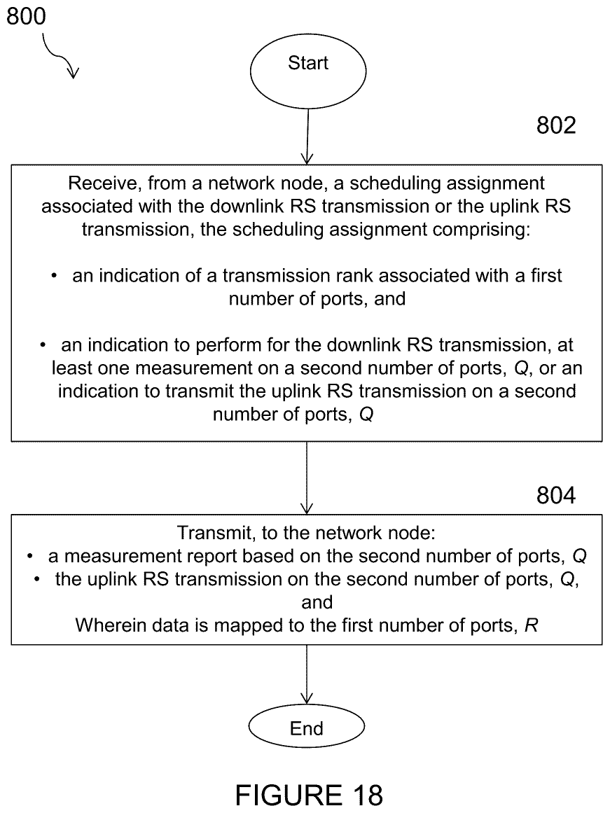

FIG. 18 illustrates a method 800 by a UE 112 for extending RS for a downlink RS transmission and/or an uplink RS transmission, according to certain embodiments. The method begins at step 802 when the UE 112 receives, from a network node 110, a scheduling assignment associated with the downlink RS transmission or the uplink RS transmission. The scheduling assignment includes: an indication of a transmission rank associated with a first number of ports, R. Additionally, the scheduling assignment includes: an indication to perform, for the downlink RS transmission, at least one measurement on a second number of ports, Q; or an indication to transmit the uplink RS transmission on a second number of ports, Q. At step 804, the UE 112 transmits to the network node 110: a measurement report based on the second number of ports, Q or the uplink RS transmission on the second number of ports, Q. Data is mapped to the first number of ports, R.

In a particular embodiment, the first number of ports is a subset of the second number of ports.

In a particular embodiment, the first number of ports, R, indicates a number of ports on which data is to be transmitted in the uplink RS transmission or in a downlink reception from the network node. Additionally or alternatively, the first number of ports, R, corresponds to a number of transmission layers associated with the uplink RS transmission or the downlink reception from the network node.

In a particular embodiment, the second number of ports, Q, is a maximum number of ports that the network node is to use for performing at least one measurement for the uplink RS transmission.

In a particular embodiment, the second number of ports, Q, is different from the first number of ports, R, and/or the second number of ports, Q, is greater than the first number of ports, R,

In a particular embodiment, at least one of:
at least one of the second number of ports, Q, is associated with a lower RS density in time and/or frequency than the first number of ports, R;
at least one of the second number of ports, Q, is not associated with any one of the first number of ports, R;
at least one of the second number of ports, Q, is used only for performing at least one measurement; and
each of the first number of ports, R, are used for both demodulation and performing at least one measurement.

In a particular embodiment, the UE 112 obtains a value for the second number of ports, Q, and obtaining the value for the second number of ports, Q, comprises at least one of:
receiving the value for the second number of ports, Q, via higher layer signaling;
receiving the value for the second number of ports, Q, via a Radio Resource Control message;
determining the value for the second number of ports, Q, based on a configuration and/or specification;
receiving the value for the second number of ports, Q, via a Downlink Control Information message that includes the scheduling assignment; and
receiving the value for the second number of ports, Q, via a second DCI message that is separate from a first DCI message that includes the scheduling assignment.

In a particular embodiment, the UE 112 receives, from the network node 110, a measurement report based on the second number of ports, Q. The measurement report is a CQI report and/or wherein the measurement report comprises at least one value associated with at least one SRS measurement.

In a particular embodiment, the uplink RS transmission is transmitted via PUSCH, and/or the uplink RS transmission comprises a DMRS.

In a particular embodiment, the UE 112 transmits, to the network node 110, an indication of a preferred transmission rank, and the preferred rank is between 0 and a value associated with the second number of ports, Q.

In a further particular embodiment, the UE 112 receives, from the network node 110, a message requesting the UE 112 to provide the indication of the preferred transmission rank to the network node 110.

In a particular embodiment, the UE 112 determines to provide the indication of the preferred rank to the network node based on a value of the second number of ports, Q, being greater than a value of the first number of ports, R.

In a particular embodiment, the scheduling assignment indicates that the uplink RS transmission does not carry payload data and/or that the transmission rank is zero.

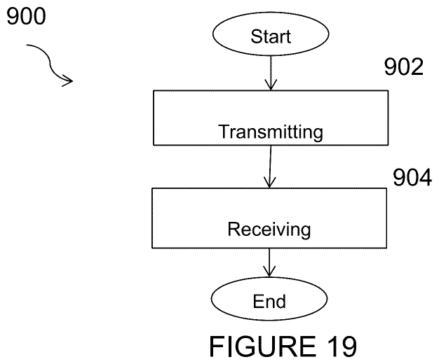

FIG. 19 illustrates an example method by a network node for extending RS for measurements for a downlink RS transmission, according to certain embodiments. In the illustrated embodiment, the method 900 includes a transmitting step at 902 and a receiving step at 904.

For example, according to certain embodiments, at step 902, the network node may transmit, to a UE, a scheduling assignment associated with the downlink RS transmission. In a particular embodiment, the scheduling assignment includes an indication of a transmission rank associated with a first number of ports, R, and an indication to perform at least one measurement on a second number of ports, Q. At step 904, for example, the network node may receive, from the UE, a measurement report based on the second number of ports, Q.

As another example, according to certain embodiments relating to the uplink, at step 902, the network node may transmit, to a UE, a scheduling assignment associated with the uplink RS transmission. The scheduling assignment includes an indication of a transmission rank associated with a first number of ports, R, and an indication to transmit the uplink RS transmission on a second number of ports, Q. At step 904, for example, the network node receives, from the UE, the uplink RS transmission on the second number of ports, Q. In the uplink RS transmission, data is mapped only to the first number of ports, R.

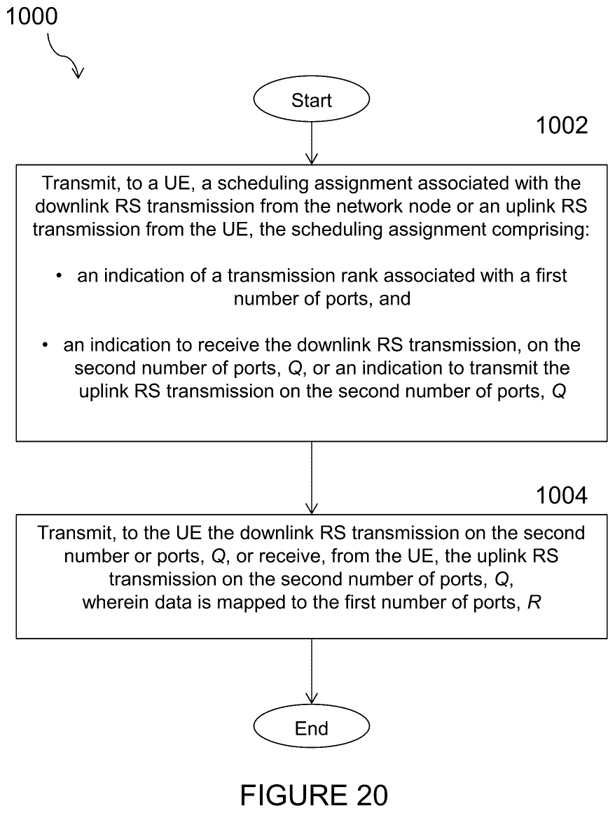

FIG. 20 illustrates a method 1000 by a network node 110 for extending RS for measurements, according to certain embodiments. The method begins at step 1002 when the network node 110 transmits, to a UE 112, a scheduling assignment associated with a downlink RS transmission from the network node or an uplink RS transmission from the UE. The scheduling assignment includes an indication of a transmission rank associated with a first number of ports, R, and an indication to receive the downlink RS transmission on a second number of ports, Q, or an indication to transmit the uplink RS transmission, on the second number of ports, Q. The network node 110 transmits, to the UE 112, the downlink RS transmission on the second number of ports, Q or receives, from the UE, the uplink RS transmission on the second number of ports, Q, at step 1004. Data is mapped to the first number of ports, R.

In a particular embodiment, the first number of ports is a subset of the second number of ports.

In a particular embodiment, the first number of ports, R, indicates a number of ports on which data is to be transmitted to the UE 112 in the downlink RS transmission or received by the network node 110 in the uplink RS transmission from the UE 112. Additionally or alternatively, the first number of ports, R, corresponds to a number of transmission layers associated with the uplink RS transmission from the UE 112 or the downlink transmission from the network node 110.

In a particular embodiment, the second number of ports, Q, is a maximum number of ports that the network node 110 is to use for performing the at least one measurement based on the uplink RS transmission received on the second number of ports, Q.

In a particular embodiment, the second number of ports, Q, is different from the first number of ports, R, and/or the second number of ports, Q, is greater than the first number of ports, R.

In a particular embodiment, at least one of:
at least one port of the second number of ports, Q, is associated with a lower RS density in time and/or frequency than the first number of ports, R;
at least one port of the second number of ports, Q, is not associated with any one of the first number of ports, R;
at least one port of the second number of ports, Q, is used only for performing at least one measurement; and
each of the first number of ports, R, are used for both demodulation and performing the at least one measurement.

In particular embodiments, the network node 110 obtains a value for the second number of ports, Q, and obtaining the value for the second number of ports, Q, includes at least one of:
receiving the value for the second number of ports, Q, via higher layer signaling;
receiving the value for the second number of ports, Q, via a Radio Resource Control message;
determining the value for the second number of ports, Q, based on a configuration and/or specification;
receiving the value for the second number of ports, Q, via a Downlink Control Information message that includes the scheduling assignment; and
receiving the value for the second number of ports, Q, via a second DCI message that is separate from a first DCI message that includes the scheduling assignment.

In a particular embodiment, the network node 110 performs at least one measurement based on the uplink RS transmission received on the second number of ports, Q.

In a further particular embodiment, the network node 110 transmits, to the UE 112, a measurement report, which include at least one value associated with the at least one measurement performed based on the uplink RS transmission received on the second number of ports, Q.

In a further particular embodiment, the measurement report is a CQI report and/or the measurement report includes at least one value associated with at least one SRS measurement.

In a particular embodiment, the uplink RS transmission is transmitted from the UE 112 to the network node 110 via a physical uplink shared channel, and/or the uplink RS transmission comprises a DMRS.

In a particular embodiment, the network node 110 receives, from the UE 112, an indication of a preferred transmission rank, and the preferred rank is between 0 and a value associated with the second number of ports, Q.

In a particular embodiment, the network node 110 transmits, to the UE 112, a message requesting the UE 112 to provide the indication of the preferred transmission rank to the network node 110.

In a particular embodiment, the scheduling assignment indicates that the uplink RS transmission does not carry payload data and/or that the transmission rank is zero.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for extending RS for measurements for a downlink transmission, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for extending RS for measurements for a downlink transmission, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a UE for extending RS for measurements for a downlink RS transmission, the method comprising: receiving, from a network node, a scheduling assignment associated with the downlink RS transmission, the scheduling assignment comprising: an indication of a transmission rank associated with a first number of ports, R, and an indication to perform at least one measurement on a second number of ports, Q; and transmitting, to the network node, a measurement report based on the second number of ports, Q.

Example Embodiment C2. The method of Example Embodiment C1, wherein at least one of: the first number of ports, R, indicates a number of ports on which data is to be received in the downlink RS transmission, and the first number of ports, R, corresponds to a number of transmission layers associated with the downlink RS transmission.

Example Embodiment C3. The method of any one of Example Embodiments C1 to C2, wherein the second number of ports, Q, is a maximum number of ports that the UE is to use for performing the at least one measurement for the downlink RS transmission.

Example Embodiment C4. The method of any one of Example Embodiments C1 to C3, wherein the second number of ports, Q, is different from the first number of ports, R.

Example Embodiment C5. The method of any one of Example Embodiments C1 to C4, wherein the second number of ports, Q, is greater than the first number of ports, R.

Example Embodiment C6. The method of Example Embodiment C5, wherein at least one of the second number of ports, Q, is not associated with any one of the first number of ports, R.

Example Embodiment C7. The method of any one of Example Embodiments C5 to C6, wherein at least one of: at least one of the second number of ports, Q, is associated with a lower RS density in time and/or frequency than the first number of ports, R; at least one of the second number of ports, Q, is not associated with any one of the first number of ports, R; at least one of the second number of ports, Q, is used only for the at least one measurement; and each of the first number of ports, R, are used for both demodulation and the at least one measurement.

Example Embodiment C8. The method of any one of Example Embodiments C1 to C7, comprising obtaining a value for the second number of ports, Q.

Example Embodiment C9. The method of Example Embodiment C8, wherein obtaining the value for the second number of ports, Q, comprises at least one of: receiving the value for the second number of ports, Q, via higher layer signaling; receiving the value for the second number of ports, Q, via a RRC message; determining the value for the second number of ports, Q, based on a configuration and/or specification; receiving the value for the second number of ports, Q, via a DCI message that includes the scheduling assignment; and receiving the value for the second number of ports, Q, via a second DCI message that is separate from a first DCI message that includes the scheduling assignment.

Example Embodiment C10. The method of any one of Example Embodiments C1 to C9, wherein the measurement report comprises a CQI report.

Example Embodiment C11. The method of any one of Example Embodiments C1 to C10, comprising: receiving the downlink RS transmission, and performing the at least one measurement for the second number of ports, Q, on which the downlink RS transmission is received.

Example Embodiment C12. The method of any one of Example Embodiments C1 to C11, wherein at least one of: the downlink RS transmission is received via a PDSCH, and the downlink RS transmission comprises a DMRS.

Example Embodiment C13. The method of any one of Example Embodiments C1 to C12, comprising transmitting, to the network node, an indication of a preferred rank.

Example Embodiment C14. The method of Example Embodiment C13, wherein the preferred rank is between 0 and a value associated with the second number of ports, Q.

Example Embodiment C15. The method of any one of Example Embodiments C13 to C14, wherein the indication of the preferred rank is transmitted in the measurement report.

Example Embodiment C16. The method of any one of Example Embodiments C13 to C15, comprising receiving, from the network node, a message requesting the UE to provide the indication of the preferred rank to the network node.

Example Embodiment C17. The method of any one of Example Embodiments C13 to C15, comprising determining to provide the indication of the preferred rank to the network node based on a value of the second number of ports, Q, being greater than a value of the first number of ports, R.

Example Embodiment C18. The method of any one of Example Embodiments C1 to C17, wherein the scheduling assignment indicates that the downlink RS transmission does not carry payload data and/or that the transmission rank is zero.

Example Embodiment C19. The method of any one of Example Embodiments C1 to C18, further comprising: providing user data; and forwarding the user data to a host via the transmission to the network node.

Example Embodiment C20. A user equipment comprising processing circuitry configured to perform any of the methods of Example Embodiments C1 to C19.

Example Embodiment C21. A wireless device comprising processing circuitry configured to perform any of the methods of Example Embodiments C1 to C19.

Example Embodiment C22. A computer program comprising instructions which when executed on a computer perform any of the methods of Example Embodiments C1 to C19.

Example Embodiment C23. A computer program product comprising computer program, the computer program comprising instructions which when executed on a computer perform any of the methods of Example Embodiments C1 to C19.

Example Embodiment C24. A non-transitory computer readable medium storing instructions which when executed by a computer perform any of the methods of Example Embodiments C1 to C19.

### Group D Example Embodiments

Example Embodiment D1. A method by a network node for extending RS for measurements for a downlink RS transmission, the method comprising: transmitting, to UE, a scheduling assignment associated with the downlink RS transmission, the scheduling assignment comprising: an indication of a transmission rank associated with a first number of ports, R, and an indication to perform at least one measurement on a second number of ports, Q; and receiving, from the UE, a measurement report based on the second number of ports, Q.

Example Embodiment D2. The method of Example Embodiment D1, wherein at least one of: the first number of ports, R, indicates a number of ports on which data is to be transmitted in the downlink RS transmission, and the transmission rank, R, corresponds to a number of transmission layers associated with the downlink RS transmission.

Example Embodiment D3. The method of any one of Example Embodiments D1 to D2, wherein the second number of ports, Q, is a maximum number of ports that the UE is to use for performing the at least one measurement for the downlink RS transmission.

Example Embodiment D4. The method of any one of Example Embodiments D1 to D3, wherein the second number of ports, Q, is different from the first number of ports, R.

Example Embodiment D5. The method of any one of Example Embodiments D1 to D4, wherein the second number of ports, Q, is greater than the first number of ports, R.

Example Embodiment D6. The method of Example Embodiment D5, wherein at least one port of the second number of ports, Q, is not associated with any one of the first number of ports, R.

Example Embodiment D7. The method of any one of Example Embodiments D5 to D6, wherein at least one of: at least one port of the second number of ports, Q, is associated with a lower RS density in time and/or frequency than the first number of ports, R; at least one port of the second number of ports, Q, is not associated with any one of the first number of ports, R; at least one port of the second number of ports, Q, is used only for the at least one measurement; and each of the first number of ports, R, are used for both demodulation and the at least one measurement.

Example Embodiment D8. The method of any one of Example Embodiments D1 to D7, comprising at least one of: transmitting, to the UE, a value for the second number of ports, Q, via higher layer signaling; transmitting, to the UE, a value for the second number of ports, Q, via a RRC message; configuring the UE with a value for the second number of ports, Q; transmitting, to the UE, a value for the second number of ports, Q, via a DCI message that includes the scheduling assignment; and transmitting, to the UE, a value for the second number of ports, Q, via a second DCI message that is separate from a first DCI message includes that the scheduling assignment.

Example Embodiment D9. The method of any one of Example Embodiments D1 to D8, wherein the measurement report comprises a CQI report.

Example Embodiment D10. The method of any one of Example Embodiments D1 to C10, comprising at least one of: transmitting, to the UE, the downlink RS transmission, and configuring the UE to perform the at least one measurement for the second number of ports, Q, on which the downlink RS transmission is received.

Example Embodiment D11. The method of any one of Example Embodiments D1 to D10, wherein at least one of: the downlink RS transmission is transmitted via a PDSCH, and the downlink RS transmission comprises a DMRS.

Example Embodiment D12. The method of any one of Example Embodiments D1 to D11, comprising at least one of: receiving, from the UE, an indication of a preferred rank; and adapting a transmission of at least one subsequently transmitted downlink RS signal based on the indication of the preferred rank.

Example Embodiment D13. The method of Example Embodiment D12, wherein the preferred rank is between 0 and a value associated with the second number of ports, Q.

Example Embodiment D14. The method of any one of Example Embodiments D12 to D13, wherein the indication of the preferred rank is received in the measurement report.

Example Embodiment D15. The method of any one of Example Embodiments D12 to D14, comprising transmitting, to the UE, a message requesting the UE to provide the indication of the preferred rank to the network node.

Example Embodiment D16. The method of any one of Example Embodiments D12 to D14, comprising configuring the UE to provide the indication of the preferred rank to the network node when a value associated with the second number of ports, Q is greater than a value of the first number of ports, R.

Example Embodiment D17. The method of any one of Example Embodiments D1 to D16, wherein the scheduling assignment indicates that the downlink RS transmission does not/will not carry payload data and/or that the transmission rank is zero.

Example Embodiment D18. The method of any one of Example Embodiments D1 to D17, further comprising: obtaining user data; and forwarding the user data to a host or a user equipment.

Example Embodiment D19. A network node comprising processing circuitry configured to perform any of the methods of Example Embodiments D1 to D18.

Example Embodiment D20. A computer program comprising instructions which when executed on a computer perform any of the methods of Example Embodiments D1 to D18.

Example Embodiment D21. A computer program product comprising computer program, the computer program comprising instructions which when executed on a computer perform any of the methods of Example Embodiments D1 to D18.

Example Embodiment D22. A non-transitory computer readable medium storing instructions which when executed by a computer perform any of the methods of Example Embodiments D1 to D18.

### Group E Example Embodiments

Example Embodiment E1. A method by a UE for extending RS for measurements for an uplink RS transmission, the method comprising: receiving, from a network node, a scheduling assignment associated with the uplink RS transmission, the scheduling assignment comprising: an indication of a transmission rank associated with a first number of ports, R, and an indication to transmit the uplink RS transmission on a second number of ports, Q, and transmitting, to the network node, the uplink RS transmission on the second number of ports, Q, wherein data is mapped to the first number of ports, R.

Example Embodiment E2. The method of Example Embodiment E1, wherein at least one of: the first number of ports, R, indicates a number of ports on which data is to be transmitted in the uplink RS transmission, and the first number of ports, R, corresponds to a number of transmission layers associated with the uplink RS transmission.

Example Embodiment E3. The method of any one of Example Embodiments E1 to E2, wherein the second number of ports, Q, is a maximum number of ports that the network node is to use for performing at least one measurement for the uplink RS transmission.

Example Embodiment E4. The method of any one of Example Embodiments E1 to E3, wherein the second number of ports, Q, is different from the first number of ports, R.

Example Embodiment E5. The method of any one of Example Embodiments E1 to E4, wherein the second number of ports, Q, is greater than the first number of ports, R.

Example Embodiment E6. The method of Example Embodiment E5, wherein at least one port of the second number of ports, Q, is not associated with any one of the first number of ports, R.

Example Embodiment E7. The method of any one of Example Embodiments E5 to E6, wherein at least one of: at least one of the second number of ports, Q, is associated with a lower RS density in time and/or frequency than the first number of ports, R; at least one of the second number of ports, Q, is not associated with any one of the first number of ports, R; at least one of the second number of ports, Q, is used only for performing at least one measurement; and each of the first number of ports, R, are used for both demodulation and performing at least one measurement.

Example Embodiment E8. The method of any one of Example Embodiments E1 to E7, comprising obtaining a value for the second number of ports, Q.

Example Embodiment E9. The method of Example Embodiment E8, wherein obtaining the value for the second number of ports, Q, comprises at least one of: receiving the value for the second number of ports, Q, via higher layer signaling; receiving the value for the second number of ports, Q, via a RRC message; determining the value for the second number of ports, Q, based on a configuration and/or specification; receiving the value for the second number of ports, Q, via a DCI message that includes the scheduling assignment; and receiving the value for the second number of ports, Q, via a second DCI message that is separate from a first DCI message that includes the scheduling assignment.

Example Embodiment E10. The method of any one of Example Embodiments E1 to E9, comprising receiving, from the network node, a measurement report based on the second number of ports, Q.

Example Embodiment E11. The method of Example Embodiment E10, wherein the measurement report is a channel quality indicator, CQI, report and/or wherein the measurement report comprises at least one value associated with at least one SRS measurement.

Example Embodiment E12. The method of any one of Example Embodiments E1 to E11, wherein at least one of: the uplink RS transmission is transmitted via a PUSCH, and the uplink RS transmission comprises a DMRS.

Example Embodiment E13. The method of any one of Example Embodiments E1 to E12, comprising transmitting, to the network node, an indication of a preferred transmission rank.

Example Embodiment E14. The method of Example Embodiment E13, wherein the preferred rank is between 0 and a value associated with the second number of ports, Q.

Example Embodiment E15. The method of any one of Example Embodiments E13 to E14, comprising receiving, from the network node, a message requesting the UE to provide the indication of the preferred transmission rank to the network node.

Example Embodiment E16. The method of any one of Example Embodiments E13 to E15, comprising determining to provide the indication of the preferred rank to the network node based on a value of the second number of ports, Q, being greater than a value of the first number of ports, R.

Example Embodiment E17. The method of any one of Example Embodiments E1 to E16, wherein the scheduling assignment indicates that the uplink RS transmission does not carry payload data and/or that the transmission rank is zero.

Example Embodiment E18. The method of any one of Example Embodiments E1 to E17, further comprising: providing user data; and forwarding the user data to a host via the transmission to the network node.

Example Embodiment E19. A user equipment comprising processing circuitry configured to perform any of the methods of Example Embodiments E1 to E18.

Example Embodiment E20. A wireless device comprising processing circuitry configured to perform any of the methods of Example Embodiments E1 to E18.

Example Embodiment E21. A computer program comprising instructions which when executed on a computer perform any of the methods of Example Embodiments E1 to E18.

Example Embodiment E22. A computer program product comprising computer program, the computer program comprising instructions which when executed on a computer perform any of the methods of Example Embodiments C1 to C18.

Example Embodiment E23. A non-transitory computer readable medium storing instructions which when executed by a computer perform any of the methods of Example Embodiments E1 to E18.

### Group F Example Embodiments

Example Embodiment F1. A method by a network node for extending RS for measurements for an uplink RS transmission, the method comprising: transmitting, to a UE, a scheduling assignment associated with the uplink RS transmission, the scheduling assignment comprising: an indication of a transmission rank associated with a first number of ports, R, and an indication to transmit the uplink RS transmission on a second number of ports, Q, and receiving, from the UE, the uplink RS transmission on the second number of ports, Q, wherein data is mapped to the first number of ports, R; and performing at least one measurement based on the uplink RS transmission received on the second number of ports, Q.

Example Embodiment F2. The method of Example Embodiment F1, wherein at least one of: the first number of ports, R, indicates a number of ports on which data is to be transmitted by the UE and/or received by the network node in the uplink RS transmission, and the first number of ports, R, corresponds to a number of transmission layers associated with the uplink RS transmission.

Example Embodiment F3. The method of any one of Example Embodiments F1 to F2, wherein the second number of ports, Q, is a maximum number of ports that the network node is to use for performing the at least one measurement based on the uplink RS transmission received on the second number of ports, Q.

Example Embodiment F4. The method of any one of Example Embodiments F1 to F3, wherein the second number of ports, Q, is different from the first number of ports, R.

Example Embodiment F5. The method of any one of Example Embodiments F1 to F4, wherein the second number of ports, Q, is greater than the first number of ports, R.

Example Embodiment F6. The method of Example Embodiment F5, wherein at least one port of the second number of ports, Q, is not associated with any one of the first number of ports, R.

Example Embodiment F7. The method of any one of Example Embodiments F5 to F6, wherein at least one of: at least one port of the second number of ports, Q, is associated with a lower RS density in time and/or frequency than the first number of ports, R; at least one port of the second number of ports, Q, is not associated with any one of the first number of ports, R; at least one port of the second number of ports, Q, is used only for performing at least one measurement; and each of the first number of ports, R, are used for both demodulation and performing the at least one measurement.

Example Embodiment F8. The method of any one of Example Embodiments F1 to F7, comprising obtaining a value for the second number of ports, Q.

Example Embodiment F9. The method of Example Embodiment F8, wherein obtaining the value for the second number of ports, Q, comprises at least one of: receiving the value for the second number of ports, Q, via higher layer signaling; receiving the value for the second number of ports, Q, via a RRC message; determining the value for the second number of ports, Q, based on a configuration and/or specification; receiving the value for the second number of ports, Q, via a DCI message that includes the scheduling assignment; and receiving the value for the second number of ports, Q, via a second DCI message that is separate from a first DCI message that includes the scheduling assignment.

Example Embodiment F10. The method of any one of Example Embodiments F1 to F9, comprising transmitting, to the UE, a measurement report, wherein the measurement report comprises at least one value associated with the at least one measurement performed based on the uplink RS transmission on the second number of ports, Q.

Example Embodiment F11. The method of Example Embodiment F10, wherein the measurement report is a channel quality indicator, CQI, report and/or wherein the measurement report comprises at least one value associated with at least one sounding reference signal (SRS) measurement.

Example Embodiment F12. The method of any one of Example Embodiments F1 to F11, wherein at least one of: the uplink RS transmission is transmitted from the UE to the network node via a PUSCH, and the uplink RS transmission comprises a DMRS.

Example Embodiment F13. The method of any one of Example Embodiments F1 to F12, comprising receiving, from the UE, an indication of a preferred transmission rank.

Example Embodiment F14. The method of Example Embodiment F13, wherein the preferred rank is between 0 and a value associated with the second number of ports, Q.

Example Embodiment F15. The method of any one of Example Embodiments F13 to F14, comprising transmitting, to the UE, a message requesting the UE to provide the indication of the preferred transmission rank to the network node.

Example Embodiment F16. The method of any one of Example Embodiments F13 to F15, comprising determining to provide the indication of the preferred rank to the network node based on a value of the second number of ports, Q, being greater than a value of the first number of ports, R.

Example Embodiment F17. The method of any one of Example Embodiments F1 to F16, wherein the scheduling assignment indicates that the uplink RS transmission does not carry payload data and/or that the transmission rank is zero.

Example Embodiment F18. The method of any of the previous Example Embodiments, further comprising: obtaining user data; and forwarding the user data to a host or a user equipment.

Example Embodiment F19. A network node comprising processing circuitry configured to perform any of the methods of Example Embodiments F1 to F18.

Example Embodiment F20. A computer program comprising instructions which when executed on a computer perform any of the methods of Example Embodiments F1 to F18.

Example Embodiment F21. A computer program product comprising computer program, the computer program comprising instructions which when executed on a computer perform any of the methods of Example Embodiments D1 to D18.

Example Embodiment F22. A non-transitory computer readable medium storing instructions which when executed by a computer perform any of the methods of Example Embodiments F1 to F18.

### Group G Example Embodiments

Example Embodiment G1. A UE for extending RS for measurements for a downlink RS transmission, the UE comprising: processing circuitry configured to perform any of the steps of 7 any of the Group A, C, and E Example Embodiments; and power supply circuitry configured to supply power to the processing circuitry.

Example Embodiment G2. A network node for extending RS for measurements for a downlink RS transmission, the network node comprising: processing circuitry configured to perform any of the steps of any of the Group B, D, and F Example Embodiments; power supply circuitry configured to supply power to the processing circuitry.

Example Embodiment G3. A UE for extending RS for measurements for a downlink RS transmission, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, and E Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an OTT service, the host comprising: processing circuitry configured to provide user data; and a network interface configured to initiate transmission of the user data to a cellular network for transmission to a UE, wherein the UE comprises a communication interface and processing circuitry, the communication interface and processing circuitry of the UE being configured to perform any of the steps of any of the Group A, C, and E Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G7. A method implemented by a host operating in a communication system that further includes a network node and a UE, the method comprising: providing user data for the UE; and initiating a transmission carrying the user data to the UE via a cellular network comprising the network node, wherein the UE performs any of the operations of any of the Group A, C, and E Example Embodiments to receive the user data from the host.

Example Embodiment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Embodiment G10. A host configured to operate in a communication system to provide an OTT service, the host comprising: processing circuitry configured to provide user data; and a network interface configured to initiate transmission of the user data to a cellular network for transmission to a UE, wherein the UE comprises a communication interface and processing circuitry, the communication interface and processing circuitry of the UE being configured to perform any of the steps of any of the Group A, C, and E Example Embodiments to transmit the user data to the host.

Example Embodiment G11. The host of the previous Example Embodiment, wherein the cellular network further includes a network node configured to communicate with the UE to transmit the user data from the UE to the host.

Example Embodiment G12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a UE, the method comprising: at the host, receiving user data transmitted to the host via the network node by the UE, wherein the UE performs any of the steps of any of the Group A, C, and E Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an OTT service, the host comprising: processing circuitry configured to provide user data; and a network interface configured to initiate transmission of the user data to a network node in a cellular network for transmission to a UE, the network node having a communication interface and processing circuitry, the processing circuitry of the network node configured to perform any of the operations of any of the Group B, D, and F Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, D, and F Example Embodiments to transmit the user data from the host to the UE.

Example Embodiment G19. The method of the previous Example Embodiment, further comprising, at the network node, transmitting the user data provided by the host for the UE.

Example Embodiment G20. The method of any of the previous 2 Example Embodiments, wherein the user data is provided at the host by executing a host application that interacts with a client application executing on the UE, the client application being associated with the host application.

Example Embodiment G21. A communication system configured to provide an OTT service, the communication system comprising: a host comprising: processing circuitry configured to provide user data for a UE, the user data being associated with the OTT service; and a network interface configured to initiate transmission of the user data toward a cellular network node for transmission to the UE, the network node having a communication interface and processing circuitry, the processing circuitry of the network node configured to perform any of the operations of any of the Group B, D, and F Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an OTT service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and F Example Embodiments to receive the user data from a UE for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a UE, the method comprising: at the host, initiating receipt of user data from the UE, the user data originating from a transmission which the network node has received from the UE, wherein the network node performs any of the steps of any of the Group B, D, and F Example Embodiments to receive the user data from the UE for the host.

Example Embodiment G27. The method of the previous Example Embodiment, further comprising at the network node, transmitting the received user data to the host.

1. A method by a user equipment, UE, for extending Reference Signals, RS, for a downlink RS transmission and/or an uplink RS transmission, the method comprising:
receiving, from a network node, a scheduling assignment associated with the downlink RS transmission or the uplink RS transmission, the scheduling assignment comprising:
an indication of a transmission rank associated with a first number of ports, R, and
an indication to perform, for the downlink RS transmission, at least one measurement on a second number of ports, Q, or an indication to transmit the uplink RS transmission on a second number of ports, Q, and
transmitting (804), to the network node:
a measurement report based on the second number of ports, Q or
the uplink RS transmission on the second number of ports, Q, and
wherein data is mapped to the first number of ports, R.

2.-13. (canceled)

14. A method by a network node for extending Reference Signals, RS, for measurements, the method comprising:
transmitting, to a user equipment, UE, a scheduling assignment associated with a downlink RS transmission from the network node or an uplink RS transmission from the UE, the scheduling assignment comprising:
an indication of a transmission rank associated with a first number of ports, R, and
an indication to receive the downlink RS transmission on a second number of ports, Q, or an indication to transmit the uplink RS transmission, on the second number of ports, Q, and
transmitting, to the UE, the downlink RS transmission on the second number of ports, Q, or receiving, from the UE, the uplink RS transmission on the second number of ports, Q, and
wherein data is mapped to the first number of ports, R.

15.-27. (canceled)

28. A user equipment, UE, for extending Reference Signals, RS, for a downlink RS transmission and/or an uplink RS transmission, the UE configured to:
receive, from a network node, a scheduling assignment associated with the downlink RS transmission or the uplink RS transmission, the scheduling assignment comprising:
an indication of a transmission rank associated with a first number of ports, R, and
an indication to perform, for the downlink RS transmission, at least one measurement on a second number of ports, Q, or an indication to transmit the uplink RS transmission on a second number of ports, Q, and
transmit, to the network node:
a measurement report based on the second number of ports, Q or
the uplink RS transmission on the second number of ports, Q, and
wherein data is mapped to the first number of ports, R.

29. The UE of claim 28, wherein the first number of ports is a subset of the second number of ports.

30. The UE of claim 28, wherein at least one of:
the first number of ports, R, indicates a number of ports on which data is to be transmitted in the uplink RS transmission or in a downlink reception from the network node, and
the first number of ports, R, corresponds to a number of transmission layers associated with the uplink RS transmission or in the downlink reception from the network node.

31. The UE of claim 28, wherein the second number of ports, Q, is a maximum number of ports that the network node is to use for performing at least one measurement for the uplink RS transmission.

32. The UE of claim 28, wherein at least one of:
the second number of ports, Q, is different from the first number of ports, R, and
the second number of ports, Q, is greater than the first number of ports, R.

33. The UE method of claim 28, wherein at least one of:
at least one of the second number of ports, Q, is associated with a lower RS density in time and/or frequency than the first number of ports, R;
at least one of the second number of ports, Q, is not associated with any one of the first number of ports, R;
at least one of the second number of ports, Q, is used only for performing at least one measurement; and
each of the first number of ports, R, are used for both demodulation and performing at least one measurement.

34. The UE of claim 28, wherein the UE is configured to obtain a value for the second number of ports, Q, wherein when obtaining the value for the second number of ports, Q, the UE is configured to perform at least one of:
receive the value for the second number of ports, Q, via higher layer signaling;
receive the value for the second number of ports, Q, via a Radio Resource Control message;
determine the value for the second number of ports, Q, based on a configuration and/or specification;
receive the value for the second number of ports, Q, via a Downlink Control Information message that includes the scheduling assignment; and
receiving the value for the second number of ports, Q, via a second DCI message that is separate from a first DCI message that includes the scheduling assignment.

35. The UE of claim 28, wherein the UE is configured to receive, from the network node, a measurement report based on the second number of ports, Q, wherein the measurement report is a channel quality indicator, CQI, report and/or wherein the measurement report comprises at least one value associated with at least one sounding reference signal, SRS, measurement.

36. The UE of claim 28, wherein at least one of:
the uplink RS transmission is transmitted via a physical uplink shared channel, PUSCH, and
the uplink RS transmission comprises a Demodulation Reference Signal, DMRS.

37. The UE of claim 28, configured to transmit, to the network node, an indication of a preferred transmission rank, wherein the preferred rank is between 0 and a value associated with the second number of ports, Q.

38. The UE of claim 37, configured to receive, from the network node, a message requesting the UE to provide the indication of the preferred transmission rank to the network node.

39. The UE of claim 37, configured to determine to provide the indication of the preferred rank to the network node based on a value of the second number of ports, Q, being greater than a value of the first number of ports, R.

40. The UE of claim 28, wherein the scheduling assignment indicates that the uplink RS transmission does not carry payload data and/or that the transmission rank is zero.

41. A network node for extending Reference Signals, RS, for measurements, the network node configured to:
transmit, to a user equipment, UE, a scheduling assignment associated with a downlink RS transmission from the network node or an uplink RS transmission from the UE, the scheduling assignment comprising:
an indication of a transmission rank associated with a first number of ports, R, and
an indication to receive the downlink RS transmission on a second number of ports, Q, or an indication to transmit the uplink RS transmission on the second number of ports, Q, and
transmit, to the UE, the downlink RS transmission on the second number of ports, Q, or receive, from the UE, the uplink RS transmission on the second number of ports, Q, and
wherein data is mapped to the first number of ports, R.

42. The network node of claim 41, wherein the first number of ports is a subset of the second number of ports.

43. The network node of claim 41, wherein at least one of:
the first number of ports, R, indicates a number of ports on which data is to be transmitted to the UE in the downlink RS transmission or received by the network node in the uplink RS transmission from the UE, and
the first number of ports, R, corresponds to a number of transmission layers associated with the uplink RS transmission from the UE or the downlink transmission from the network node.

44. The network node of claim 41, wherein the second number of ports, Q, is a maximum number of ports that the network node is to use for performing the at least one measurement based on the uplink RS transmission received on the second number of ports, Q.

45. The network node of claim 41, wherein at least one of:
the second number of ports, Q, is different from the first number of ports, R, and
the second number of ports, Q, is greater than the first number of ports, R.

46. The network node of claim 41, wherein at least one of:
at least one port of the second number of ports, Q, is associated with a lower RS density in time and/or frequency than the first number of ports, R;
at least one port of the second number of ports, Q, is not associated with any one of the first number of ports, R;
at least one port of the second number of ports, Q, is used only for performing at least one measurement; and
each of the first number of ports, R, are used for both demodulation and performing the at least one measurement.

47. The network node of claim 41, configured to obtain a value for the second number of ports, Q, and wherein when obtaining the value for the second number of ports, Q, the network node is configured to perform at least one of:
receiving the value for the second number of ports, Q, via higher layer signaling;
receiving the value for the second number of ports, Q, via a Radio Resource Control message;
determining the value for the second number of ports, Q, based on a configuration and/or specification;
receiving the value for the second number of ports, Q, via a Downlink Control Information message that includes the scheduling assignment; and
receiving the value for the second number of ports, Q, via a second DCI message that is separate from a first DCI message that includes the scheduling assignment.

48. The network node of claim 41, configured to perform at least one measurement based on the uplink RS transmission received on the second number of ports, Q.

49. The network node of claim 48, configured to transmit, to the UE, a measurement report, wherein the measurement report comprises at least one value associated with the at least one measurement performed based on the uplink RS transmission received on the second number of ports, Q.

50. The network node of claim 49, wherein the measurement report is a channel quality indicator, CQI, report and/or wherein the measurement report comprises at least one value associated with at least one sounding reference signal measurement.

51.-54. (canceled)
